(19) United States
(12) Patent Application Publication
(10) Pub. No.: US 2025/0274395 A1
(43) Pub. Date: Aug. 28, 2025

(54) TRAFFIC CLASSIFIER FOR SERVICE AWARE WI-FI OPERATION

(71) Applicant: QUALCOMM Incorporated, San Diego, CA (US)

(72) Inventors: Xiaolong HUANG, Santee, CA (US); Srinivas KATAR, Fremont, CA (US); Qiang FAN, Skillman, NJ (US); Gaurang NAIK, San Diego, CA (US); Nathaniel David HOUGHTON, El Cerrito, CA (US); Abhijit BHATTACHARYA, Bangalore (IN); Soumen CHAKRABORTY, Bangalore (IN)

(21) Appl. No.: 18/899,813

(22) Filed: Sep. 27, 2024

Related U.S. Application Data
(60) Provisional application No. 63/556,748, filed on Feb. 22, 2024.

(30) Foreign Application Priority Data
Feb. 22, 2024 (IN) 202441012720
Feb. 22, 2024 (IN) 202441012755

(51) Int. Cl. H04L 47/2441; H04W 28/02; H04W 74/0833

(52) U.S. Cl. CPC H04L 47/2441; H04W 28/0221; H04W 74/0833

(57) ABSTRACT

This disclosure provides methods, components, devices and systems for traffic classifier for service aware Wi-Fi operation. The techniques described herein support the creation of a common traffic detection model on an access point (AP) or client. In some examples, the model may reclassify traffic over time to avoid detection failure during an atypical traffic pattern period of an interested flow. The traffic classifier may provide traffic detection results and traffic activity such that a power saving operation may be enabled. Some aspects more specifically relate to mechanisms according to which the AP or client may select power save parameters associated with a classified traffic flow to the AP or client.

### CROSS REFERENCE TO RELATED APPLICATIONS

The present Application for Patent claims the benefit of U.S. Provisional Application No. 63/556,748 by HUANG et al., entitled “TRAFFIC CLASSIFIER FOR SERVICE AWARE WI-FI OPERATION,” filed Feb. 22, 2024, the present application also claims the benefit of India Provisional Application No. 202441012755 by KATAR et al., entitled “WI-FI CLIENT TRAFFIC CLASSIFIER FOR POWER SAVE OPERATIONS,” filed Feb. 22, 2024, and the present application also claims the benefit of India Provisional Application No. 202441012720 by BHATTACHARYA et al., entitled “POWER SAVE PARAMETER SELECTION AT A CLIENT DEVICE IN ACCORDANCE WITH A JOINT EVALUATION OF LATENCY AND POWER CONSUMPTION,” filed Feb. 22, 2024, each of which are assigned to the assignee hereof, and expressly incorporated by reference herein.

### TECHNICAL FIELD

This disclosure relates generally to wireless communication and, more specifically, to a traffic classifier for service aware Wi-Fi operation.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

Wireless communication devices may communicate in accordance with any one or more of such wireless communication technologies, and may include wireless stations (STAs), wireless access points (APs), user equipment (UEs), network entities, or other wireless nodes. In some wireless communication networks, traffic classification techniques may include deep packet inspection (DPI), where packet content is matched to an application using static rules.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a wireless node. The method may include obtaining a set of multiple samples associated with a set of multiple packets including data, detecting one or more transmission traffic patterns associated with the set of multiple packets based on one or more parameters associated with the set of multiple samples, one or more parameters associated with a previous set of multiple samples, or both, classifying, based on the one or more transmission traffic patterns, the set of multiple packets according to one or more traffic types, and communicating in accordance with the one or more traffic types.

Another innovative aspect of the subject matter described in this disclosure can be implemented in a wireless node for wireless communication. The wireless node may include a processing system that includes processor circuitry and memory circuitry that stores code. The processing system may be configured to cause the wireless node to obtain a set of multiple samples associated with a set of multiple packets including data, detect one or more transmission traffic patterns associated with the set of multiple packets based on one or more parameters associated with the set of multiple samples, one or more parameters associated with a previous set of multiple samples, or both, classify, based on the one or more transmission traffic patterns, the set of multiple packets according to one or more traffic types, and communicate in accordance with the one or more traffic types.

Another wireless node for wireless communication is described. The wireless node may include means for obtaining a set of multiple samples associated with a set of multiple packets including data, means for detecting one or more transmission traffic patterns associated with the set of multiple packets based on one or more parameters associated with the set of multiple samples, one or more parameters associated with a previous set of multiple samples, or both, means for classifying, based on the one or more transmission traffic patterns, the set of multiple packets according to one or more traffic types, and means for communicating in accordance with the one or more traffic types.

One innovative aspect of the subject matter described in this disclosure can be implemented in a non-transitory computer-readable medium storing code for wireless communication. The code may include instructions executable by one or more processors to obtain a set of multiple samples associated with a set of multiple packets including data, detect one or more transmission traffic patterns associated with the set of multiple packets based on one or more parameters associated with the set of multiple samples, one or more parameters associated with a previous set of multiple samples, or both, classify, based on the one or more transmission traffic patterns, the set of multiple packets according to one or more traffic types, and communicate in accordance with the one or more traffic types.

In some examples of the method, wireless nodes, and non-transitory computer-readable medium described herein, communicating in accordance with the one or more traffic types may include operations, features, means, or instructions for outputting scheduling information associated with the set of multiple packets, where the scheduling information may be output in accordance with a channel access scheme that may be based on the one or more traffic types.

Some examples of the method, wireless nodes, and non-transitory computer-readable medium described herein may further include operations, features, means, or instructions for obtaining one or more traffic activities, one or more traffic loads, or any combination thereof based on the one or more transmission traffic patterns, where the one or more traffic types, the one or more traffic activities, and the one or more traffic loads may be each associated with a respective traffic flow of a set of multiple traffic flows, where the set of multiple traffic flows may be associated with the set of multiple samples, and where the communication includes performing a power saving operation in accordance with the one or more traffic types, the one or more traffic activities, the one or more traffic loads, or any combination thereof.

Another innovative aspect of the subject matter described in this disclosure can be implemented in a method for wireless communications by a wireless node. The method may include obtaining information associated with a traffic flow to the wireless node, obtaining, in accordance with a classification of the traffic flow, an indication of a first set of values associated with an inactivity timeout and a second set of values associated with a poll period, selecting, at a start of a first duration and in accordance with a latency metric and a power consumption metric that are both associated with a second duration, a first value from the first set of values and a first value from the second set of values, and communicating during the first duration in accordance with at least the first value from the first set of values or the first value from the second set of values.

One innovative aspect of the subject matter described in this disclosure can be implemented in a wireless node for wireless communications. The wireless node may include a processing system that includes processor circuitry and memory circuitry that stores code. The processing system may be configured to cause the wireless node to obtain information associated with a traffic flow to the wireless node, obtain, in accordance with a classification of the traffic flow, an indication of a first set of values associated with an inactivity timeout and a second set of values associated with a poll period, select, at a start of a first duration and in accordance with a latency metric and a power consumption metric that are both associated with a second duration, a first value from the first set of values and a first value from the second set of values, and communicate during the first duration in accordance with at least the first value from the first set of values or the first value from the second set of values.

Another wireless node for wireless communications is described. The wireless node may include means for obtaining information associated with a traffic flow to the wireless node, means for obtaining, in accordance with a classification of the traffic flow, an indication of a first set of values associated with an inactivity timeout and a second set of values associated with a poll period, means for selecting, at a start of a first duration and in accordance with a latency metric and a power consumption metric that are both associated with a second duration, a first value from the first set of values and a first value from the second set of values, and means for communicating during the first duration in accordance with at least the first value from the first set of values or the first value from the second set of values.

One innovative aspect of the subject matter described in this disclosure can be implemented in a non-transitory computer-readable medium storing code for wireless communications. The code may include instructions executable by one or more processors to obtain information associated with a traffic flow to the wireless node, obtain, in accordance with a classification of the traffic flow, an indication of a first set of values associated with an inactivity timeout and a second set of values associated with a poll period, select, at a start of a first duration and in accordance with a latency metric and a power consumption metric that are both associated with a second duration, a first value from the first set of values and a first value from the second set of values, and communicate during the first duration in accordance with at least the first value from the first set of values or the first value from the second set of values.

Some examples of the method, wireless nodes, and non-transitory computer-readable medium described herein may further include operations, features, means, or instructions for outputting a frame including an indication that the wireless node may be in an awake state, where selecting the first value from the first set of values and the first value from the second set of values may be in parallel with outputting the frame.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a signaling diagram that supports a traffic classifier for service aware Wi-Fi operation.

FIG. 3 shows an example of a service aware Wi-Fi architecture that supports a traffic classifier for service aware Wi-Fi operation.

FIG. 4 shows an example of a traffic classifier architecture on an access point (AP) that supports a traffic classifier for service aware Wi-Fi operation.

FIG. 5 shows an example of a traffic classifier architecture on a station (STA) that supports a traffic classifier for service aware Wi-Fi operation.

FIG. 6 shows an example of a traffic type detection procedure that supports a traffic classifier for service aware Wi-Fi operation.

FIG. 7 shows an example of a block diagram that supports a traffic classifier for service aware Wi-Fi operation and power saving operations.

FIG. 8 shows an example of a model for traffic detection that supports a traffic classifier for service aware Wi-Fi operation.

FIG. 9 shows an example of a traffic flow that supports a traffic classifier for service aware Wi-Fi operation.

FIG. 10 shows an example of a real-time traffic block diagram that supports a traffic classifier for service aware Wi-Fi operation.

FIG. 11 shows an example of a streaming traffic block diagram that supports a traffic classifier for service aware Wi-Fi operation.

FIGS. 12A and 12B show examples of random forest model schema that support a traffic classifier for service aware Wi-Fi operation.

FIG. 13 shows an example of traffic detection logic that supports a traffic classifier for service aware Wi-Fi operation.

FIG. 14 shows examples of traffic classifier features that support a traffic classifier for service aware Wi-Fi operation.

FIG. 15 shows an example of a reclassification flow that supports a traffic classifier for service aware Wi-Fi operation.

FIG. 16 shows an example of a block diagram that supports a traffic classifier for service aware Wi-Fi operation and power saving operations.

FIG. 17 shows an example of a flow diagram that supports a traffic classifier for service aware Wi-Fi operation and power saving operations.

FIGS. 18 and 19 show examples of communication timelines that support power save parameter selection at a client device in accordance with a joint evaluation of latency and power consumption.

FIG. 20 shows examples of sleep schedules that support power save parameter selection at a client device in accordance with a joint evaluation of latency and power consumption.

FIGS. 21 and 22 show examples of block diagrams that support power save parameter selection at a client device in accordance with a joint evaluation of latency and power consumption.

FIG. 23 shows an example of a flow chart that supports power save parameter selection at a client device in accordance with a joint evaluation of latency and power consumption.

FIG. 24 shows an example of a classification that supports power save parameter selection at a client device in accordance with a joint evaluation of latency and power consumption.

FIG. 25 shows a block diagram of an example first wireless communication device that supports a traffic classifier for service aware Wi-Fi operation.

FIG. 26 shows a block diagram of an example second wireless communication device that supports a traffic classifier for service aware Wi-Fi operation.

FIGS. 27 and 28 show flowcharts illustrating example processes performable by or at a first wireless communication device or a second wireless communication device that supports a traffic classifier for service aware Wi-Fi operation.

FIG. 29 shows a flowchart illustrating example processes performable by or at a second wireless communication device that supports a traffic classifier for service aware Wi-Fi operation.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communications, service aware Wi-Fi (SAWF) may provide quality of service (QOS) (such as for Wi-Fi 6 and 7). However, SAWF may miss one or more components: the capability of detecting traffic type and identifying characteristics (hence QoS requirement). Some traffic classification techniques may include deep packet inspection (DPI), where packet content is matched to an application using static rules. DPI may face multiple challenges. For example, applications increasingly use security protocols (such as HTTPS, SSH, SSL, or the like) to guarantee user privacy. Additionally, or alternatively, high-volume traffic (such as 10+ Gbps) flowing through SAWF may introduce high complexity and hardware cost in real-time inspection and classification. It may be advantageous for traffic pattern detection-based traffic classification, online learning of traffic detection models, configurable service level agreement based on traffic detection results, and the distribution and consolidation of traffic detection across multiple mesh agents.

The techniques described herein support the creation of a common traffic detection model on a wireless communication device, such as on an AP and client (such as another AP or STA). For example, the techniques may support training and creating a model (such as an artificial intelligence (AI) or machine learning (ML) model) by combining a two-stage random forest model and a time domain autoencoder using data collected by both APs and clients simultaneously and downlink and uplink simultaneously to detect real-time traffic, streaming traffic, and any traffic that is not real-time or streaming. The model may be trained by feeding both offline information (via stored samples) and online information (such as traffic is transmitted) into a cloud server with a labeling method, including using stream classification service (SCS) QoS characteristics and one or more atypical portions of the traffic that are already detected from other portions of a long-duration traffic flow. In some examples, the model may reclassify traffic over time to avoid detection failure during an atypical traffic pattern period of an interested flow.

Additionally, or alternatively, the techniques described herein support configuration of service level agreement (SLA) based on a traffic detection result. An AP may use detection results, configure SLA and operations for traffic flows for downlink and uplink trigger-based physical layer protocol data unit (TB-PPDU) transmissions, including enhanced distributed channel access (EDCA), scheduling objectives, and signaling clients to prioritize traffic into proper traffic identifier (TID) or QoS rules. The AP may provide specific EDCA-based triggers on the uplink when a client does not support differentiated service code point (DSCP) policy installation. A STA may use the detection results, configure SLA and operations for traffic flows for uplink single-user (SU) transmissions, including EDCA, and scheduling objectives using signaling APs to prioritize traffic into proper TID or QoS rules and SCS. In some examples, an AP or a client may distribute and consolidate traffic detection across multiple APs in a mesh. For example, an AP or client may create a traffic detection model based on multiple APs' traffic input data and apply traffic detection in the inference stage with multiple APs' traffic inputs and detection results. The AP or client may apply different levels of SAWF operations on a flow based on the confidence level from the detection results from multiple APs in a mesh.

In some examples, the traffic classifier may supply both traffic detection results and traffic activity and load information to implement a power saving operation. For example, the traffic classifier may provide the traffic detection results and traffic activity such that a power saving operation may be enabled based on a combination of multiple traffic types, traffic activity, and/or traffic load.

Additionally, or alternatively, the wireless communication device may select power save parameters associated with a traffic flow classified by the traffic classifier. Such power save parameters may include one or more of an inactivity timeout (ITO) value, a speculative poll period (SPP) value, a delivery traffic indication map (DTIM) periodicity, and a sleep mode associated with the SSP value. In some implementations, the wireless communication device may select the ITO value and the SPP value in accordance with a joint evaluation of a latency metric and a power consumption metric associated with a previous decision epoch. For example, in accordance with selecting a previous ITO value and a previous SPP value for the previous decision epoch, the wireless communication device may incur some penalty (such as cost) in terms of latency and power consumption. The wireless communication device may use such latency and power consumption penalties (or metrics) to compute (such as determine, select, ascertain, estimate, predict, or otherwise obtain) a penalty value. Such a penalty value, although derived in accordance with a joint evaluation of the latency metric and the power consumption metric, may be understood as being associated with the previous ITO value and the previous SPP value as the selection of the previous ITO value and the previous SPP value resulted in the latency and power consumption penalties.

The wireless communication device may compute various penalty values over time (such as across multiple decision epochs) and may store the computed penalty values such that each penalty value is associated with a respective ITO-SPP value pair. In this way, the wireless communication device may obtain more complete knowledge of the penalty values associated with different ITO-SPP value pairs over time and may select ITO-SPP value pairs associated with the relatively smallest penalty values (which may suitably balance a power-latency tradeoff at the wireless communication device for a given traffic flow).

Particular implementations of the subject matter described in this disclosure can be implemented to realize one or more of the following potential advantages. For example, by supporting monitoring via the traffic classifier and performing power saving operations under threshold conditions, the wireless communication device may efficiently obtain knowledge of which traffic flows are present and may provide a suitable (such as flow-specific) power-latency tradeoff (including power savings). That is, enabling power saving on the wireless communication device may degrade traffic performance, but if the power saving is implemented based on conditions under which the degraded traffic performance is suitable to a latency requirement associated with a traffic flow, the wireless communication device may support both power savings and latency requirements. A configuration for power saving operations at a client may be based on both traffic types and traffic load conditions. For example, the configuration for power saving operations at the client may be based on a performance target (such as latency) at the client. Further, in accordance with reinforcing or updating activity of traffic flows, the wireless communication device may be able to stay up-to-date and current on the active traffic flows at the wireless communication device, thereby allowing the wireless communication device to update performance of a power saving operation accordingly and support the power-latency tradeoff accordingly.

Additionally, by supporting such a selection of an ITO-SPP value pair in accordance with tracking penalty values for different potential ITO-SPP value pairs over time, the wireless communication device may efficiently obtain knowledge of which ITO-SPP value pairs are relatively more likely to provide a suitable (such as flow-specific) power-latency tradeoff (including power savings). Further, in accordance with reinforcing or updating that knowledge over time, the wireless communication device may be able to stay up-to-date and current on environmental or other variations that impact the power-latency tradeoff at the wireless communication device, which may enable the wireless communication device to dynamically adjust ITO and SPP values in accordance with changing traffic patterns (even, for example, for a same application or for a same traffic type or class) or changing environmental conditions (such as a changing congestion profile). Further, the wireless communication device may leverage one or more reinforcement learning (RL) models or algorithms to dynamically account for such changes over time with scalability, as the RL models or algorithms may be able to account for a wide variation of changes, classifications, patterns, and network conditions that may otherwise involve the use of many separately defined and maintained tables. Thus, in addition to achieving power savings while still satisfying a latency constraint, the wireless communication device may achieve more efficient memory usage, which may increase a capability and use experience associated with the wireless communication device, among other benefits.

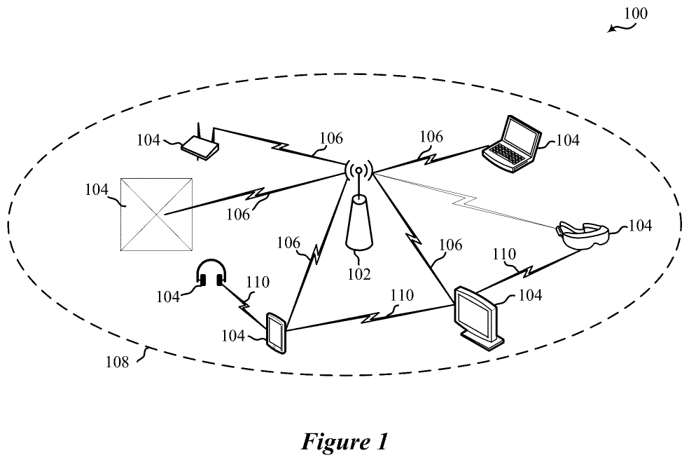

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (cNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHz-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHZ, 80 MHZ, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized. A wireless node may refer to a wireless communication device, such as an AP (such as AP 102) or a STA (such as STA 104) that communicates via the wireless communication network 100.

The techniques described herein support the creation of a common traffic detection model on an AP and client (such as another AP or STA). For example, the techniques may support training and creating a model (such as an artificial intelligence (AI) or machine learning (ML) model) by combining a two-stage random forest model and a time domain autoencoder using data collected by both APs and clients simultaneously and downlink and uplink simultaneously to detect real-time traffic, streaming traffic, and any traffic that is not real-time or streaming. The model may be trained by feeding both offline (via stored samples) and online (such as traffic is transmitted) into a cloud server with a labeling method, including using stream classification service (SCS) QoS characteristics and one or more atypical portions of the traffic that are already detected from other portions of a long-duration traffic flow. In some examples, the model may reclassify traffic over time to avoid detection failure during an atypical traffic pattern period of an interested flow.

Additionally, or alternatively, the techniques described herein support configuration of service level agreement (SLA) based on a traffic detection result. An AP may use detection results, configure SLA and operations for traffic flows for downlink and uplink trigger-based physical layer protocol data unit (TB-PPDU) transmissions, including enhanced distributed channel access (EDCA), scheduling objectives, and signaling clients to prioritize traffic into proper traffic identifier (TID) or QoS rules. The AP may provide specific EDCA-based triggers on the uplink when a client does not support differentiated service code point (DSCP) policy installation. A STA may use the detection results, configure SLA and operations for traffic flows for uplink single-user (SU) transmissions, including EDCA, and scheduling objectives using signaling APs to prioritize traffic into proper TID or QoS rules and SCS. In some examples, an AP or a client may distribute and consolidate traffic detection across multiple APs in a mesh. For example, an AP or client may create a traffic detection model based on multiple APs' traffic input data and apply traffic detection in the inference stage with multiple APs' traffic inputs and detection results. The AP or client may apply different levels of SAWF operations on a flow based on the confidence level from the detection results from multiple APs in a mesh.

Wi-Fi may include multiple features to improve user experience if an application can communicate SLA. However, in some wireless communication systems (such as systems that do not support the techniques described herein), few of these features are getting triggered due to a disconnect between Wi-Fi and the application. For example, a user may experience a larger latency in wireless communication systems due to a lack of SLAs compared to wireless communication systems that support the communication of SLA.

The techniques described herein may support a framework for online learning of a traffic detection model. For example, APs may collect traffic statistics and send them to the cloud to learn new traffic types and requirements. When a SCS is requested for a flow (such as an internet protocol (IP) tuple flow) by a client, an AP may look into the delay bound and service interval and throughput to label the traffic for training. In some examples, the traffic may have stringent delay bound and service interval requirements. In such examples, the AP may mark the traffic as real-time traffic and add the traffic traces to real-time AIML model training. In some examples, the traffic may have comparatively much less stringent delay bound but stringent throughput requirements, and the traffic may come with large bursts and idle period. In such examples, the AP may mark the traffic as streaming traffic and add the traffic traces to streaming AIML model training.

In some examples, the model may be trained and created online by using 802.11 stream classification service (SCS) request from clients to label traffic samples as training samples. Additionally, or alternatively, the model may be trained and created online by using 802.11 SCS request from clients to label the portion of traffic flow as training samples that are not detected to be its corresponding traffic types if other portion of the traffic flow is detected as its corresponding traffic types. For example, the model may detect whether one or more portions of the traffic flow correspond to respective transmission traffic types. Based on the observed STA's compliance to uplink DSCP policy installation, the AP may provide specific EDCA based triggers on the uplink for traffic types detected that need urgent uplink access.

Based on the collected traffic statistics of long duration, an AP may check if a certain portion of the traffic activity may not be detected properly and use the collected data as new training samples to retrain the model with the right label (a more accurate label). In some examples, the AP may retrain the model with the right label based on other positive detections, additional metadata collected for the long duration flow, or both.

An AP, client (such as a STA), or both, may support an SLA with the traffic classifier. For example, an AP or client may configure SLA in SAWF using traffic detection results. The AP or client may configure the SLA based on a ML confidence level. For example, the decision may not be black and white because both the random forest model and autoencoder may indicate a confidence level of its detection results. If the confidence level is relatively low, the AP or client may start with a best effort access category (AC_BE) with SLA. In examples with relatively high confidence, the AP or client may go to a voice access category (AC_VO).

In some examples, the AP or client may avoid medium-access channel service data unit (MSDU) reordering when moving from lower to higher access category (AC). The AP or client may move MSDU queues and wait for medium-access channel protocol data units (MPDUs) to be sent from a previous (old) TID. In some examples, the AP or client may temporarily change EDCA setting for the TID.

An AP may send DSCP with UP policy to a STA and identify a flow (such as IP 5-tuple) with TID or QoS to use for STA. In some examples, the STA may not change the TID queue. Additionally, or alternatively, an AP may send triggers for such flows with higher priority using higher AC random backoff engine. The AP may prioritize all flows of the same TID belonging to the client as long as at least one flow is detected with a stringent latency requirement.

In some examples, a client may not support a QoS DSCP policy capability (such as QoS R2 DSCP Policy). In such examples, a host may track a total moving average data rate of classified and prioritized uplink flows for the client, R. Firmware (FW) may estimate the buffer size according to equation 1:

Buffer Size=max(BSR/QoS control queue size, OFDMA trigger size)

The FW may track elapsed time from the last prioritized trigger to the peer. In some examples, the FW may set the prioritized trigger size according to equation 2:

Trigger Size=min(BE TID, K*R*elapsed time from last service)

In some examples, K may be set to 2.0 with a minimum value of 1. The STA may have both latency flows and throughput flows on the same TID, but the STA may not prioritize the delivery of latency flows in its uplink scheduler. For example, if the ratio of the R_prio_flow/R_BE_TID<0.25 or some other value over some observation window, do not set up the priority trigger. The host may make this determination before sending down the WMI command to FW to prioritize the flow. In some examples without a higher backoff engine trigger, the incumbent MU EDCA of AC_BE may be regular EDCA setting, when using higher trigger. Additionally, or alternatively, when using higher AC trigger, the MU EDCA should be set to the incumbent MU EDCA of AC_BE (such as the trigger MU EDCA logic may ignore triggers and uplink responses when determining the MU EDCA setting). For a flow with a service interval configured, deterministic triggers may be sent out periodically service interval apart. The estimate buffer size may consider deterministically configured burst size rather than OFDMA trigger size.

In some examples (such as in mesh latency FR development), uplink prioritization alone may not work better than no prioritization when there are many uplink STAs with sufficient uplink traffic to prioritize due to higher AC aggressive contention.

In some examples, uplink higher AC triggers for lower TID buffer status report (BSR). In such examples, clients may support a QOS DSCP policy capability (such as QoS R2 DSCP Policy), and the AP may send a traffic classification (TCLAS) attribute corresponding to the classified and prioritized uplink flow in the QoS management element in the DSCP Policy Request frame to the client to have the client prioritize an uplink flow (such as IP-tuple flow) to a higher TID.

In some examples, clients may not support the QoS DSCP policy capability. In such examples, a host may track a total moving average data rate of classified and prioritized uplink flows for the client. Firmware (FW) may estimate the buffer size according to equation 1. The FW may track elapsed time from the last prioritized trigger to the peer. In some examples, the FW may set the prioritized trigger size according to equation 2. In some examples, K may be set to 2.0 with a minimum value of 1. The STA may have both latency flows and throughput flows on the same TID, but the STA may not prioritize the delivery of latency flows in its uplink scheduler. For example, if the ratio of the R_prio_flow/R_BE_TID<0.25 or some other value over some observation window, do not set up the priority trigger. The host may make this determination before sending down the WMI command to FW to prioritize the flow. In some examples without a higher backoff engine trigger, the incumbent MU EDCA of AC_BE may be regular EDCA setting, when using higher backoff engine trigger.

Additionally, or alternatively, when using higher AC trigger, the MU EDCA should be set to the incumbent MU EDCA of AC_BE (such as the trigger MU EDCA logic may ignore triggers and uplink responses when determining the MU EDCA setting). For a flow with a service interval configured, deterministic triggers may be sent out periodically service interval apart. The estimate buffer size may consider deterministically configured burst size rather than OFDMA trigger size.

In some examples, the client may generate an SCS request. For example, once configured by customer via API, the client may set up an uplink SCS session for the AP (such as TCLAS IE: IP 2-tuple, IP 5-tubple and QOS IE: uplink TID, uplink Service Interval, uplink Delay Bound, uplink Throughput). Once configured by the customer via API, the client may set up a downlink SCS session for the AP (such as TCLAS IE: IP 2-tuple, IP 5-tubple and QoS IE: downlink TID, downlink Service Interval, downlink Delay Bound, downlink Throughput).

The techniques described herein may support distribution and consolidation of traffic detection across multiple mesh agents. For example, for a traffic flow that is going through multiple agents (such as APs or clients) in a mesh, the multiple agents on the E2E path of the flow may provide traffic pattern information to collectively learn the AIML based traffic detection model. Each agent may report the traffic pattern it sees to the root-AP. Based on the traffic being labeled, the root-AP may have an AIML model that take features from multiple hops (this may be useful for downlink and uplink traffic arrival statistics features, where downlink and uplink statistics may be perturbed by different overlapping basic service sets (OBSS) interference). Besides the traffic pattern input provided by repeater agents in a mesh, the model on the root-AP may include the detection results from the repeaters as part of the detection feature for a final verdict of the traffic types (such as using voting or some other decision-making method). Once the traffic detection results is reached at the root-AP, the root-AP may distribute the detection result to multiple agents for them to apply SAWF operation rules.

A traffic classifier may be used to support a power saving operation and improve reliability. For example, the traffic classifier may be used to support a power saving operation and improve reliability for video streaming applications, real-time traffic (such as including voice, video conference, and/or gaming), and/or background traffic at a client device.

In some wireless communication systems, wireless communication between an AP 102 and an associated STA 104 may be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

In some implementations, a wireless communication device (such as a client device, such as a STA 104) may support one or more mechanisms according to which the wireless communication device can select and communicate in accordance with a set of power save parameters associated with a traffic flow to the wireless communication device. Such power save parameters may include an ITO value, an SPP value, a DTIM periodicity, and a sleep mode. In accordance with some example implementations, the wireless communication device may leverage one or more classification models or algorithms and one or more selection models or algorithms. The classification models or algorithms may be associated with a classification of a traffic flow as a traffic class, along with, in some examples, mapping the traffic class to a traffic type bucket. The selection models or algorithms may include one or more RL models or algorithms as part of a larger RL framework. The selection models or algorithms may take, as an input, information associated with a traffic type bucket (corresponding to the active traffic flow to the wireless communication device) and may output an indication of one or more power save parameters.

The wireless communication device may communicate (such as transmit or monitor) in accordance with the power save parameters obtained from the selection models or algorithms. In some examples, such communication may include or be associated with a transmission of an uplink frame in accordance with a speculative wakeup after a duration associated with an SPP value output from the selection models or algorithms. Additionally, or alternatively, such communication may include or be associated with monitoring a channel or link for a duration associated with an ITO value output from the selection models or algorithms and an entrance into a sleep state after the duration associated with the ITO value expires.

Further, the wireless communication device may support one or more signaling mechanisms, such as frame transmissions or frame receptions, in accordance with one or more of the implementations disclosed herein. For example, the wireless communication device may transmit an indication of a classification of a traffic flow as a traffic class, or an indication of a traffic type bucket corresponding to the traffic class, to an AP 102 via one or more of various types of uplink frames. Additionally, or alternatively, the wireless communication device may transmit or receive, to or from an AP 102 or another wireless communication device, information indicative of any one or more parameters, values, variables, or factors that the wireless communication device may use for either or both of the one or more classification models or algorithms or the one or more selection models or algorithms. Additionally, or alternatively, the wireless communication device may transmit, to an AP 102 or another wireless communication device, information indicative of a capability of the wireless communication device to support any one or more of the power save parameter selection schemes disclosed herein. Additionally, or alternatively, the wireless communication device may receive, from an AP 102 or another wireless communication device, information indicative of an activation or a deactivation of any one or more of the power save parameter selection schemes disclosed herein.

Various aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and update its output based on a combination of the input data and the weights.

In some aspects, an ML model may be configured to provide computing capabilities for wireless communications. Such an ML model may be configured with weights and biases to perform traffic flow classification or power save parameter selection. Thus, during operation of a device, the ML model may receive input data (such as information associated with a traffic flow, a set of ITO-SPP candidate values, a latency constraint, a congestion value, an estimated power consumption, or an estimated latency) and make inferences (such as traffic classification or selection of an ITO-SPP value pair) based on the weights and biases.

ML models may be deployed in one or more devices (such as APs, network entities, and client devices) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, security, and the like.

ML models may be characterized in terms of types of learning that generate specific types of learned models that perform specific types of tasks. For example, different types of machine learning include supervised learning, unsupervised learning, semi-supervised learning, RL, and the like. ML models may be used to perform different tasks such as classification or regression, where classification refers to determining one or more discrete output values from a set of predefined output values, and regression refers to determining continuous values which are not bounded by predefined output values. For example, a classification ML model configured according to aspects of this disclosure may produce an output which includes an indication of a traffic class, an indication of a latency configuration, or an indication of a traffic type bucket. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), random forest models, support vector networks (SVMs), and probabilistic graphical models (such as a Bayesian network), multi-armed bandit models, and the like. In some aspects of this disclosure, two advantageous ML models for processing the input data are a random forest model and a multi-armed bandit model, in which the random forest model may improve the efficiency of processing the input data by classifying traffic flows and in which the multi-armed bandit model may improve a latency-power tradeoff by selecting one or more power save parameters.

The description herein illustrates, by way of some examples, how one or more tasks or problems in wireless communications may benefit from the application of one or more ML models to support traffic flow classification and power save parameter selection. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

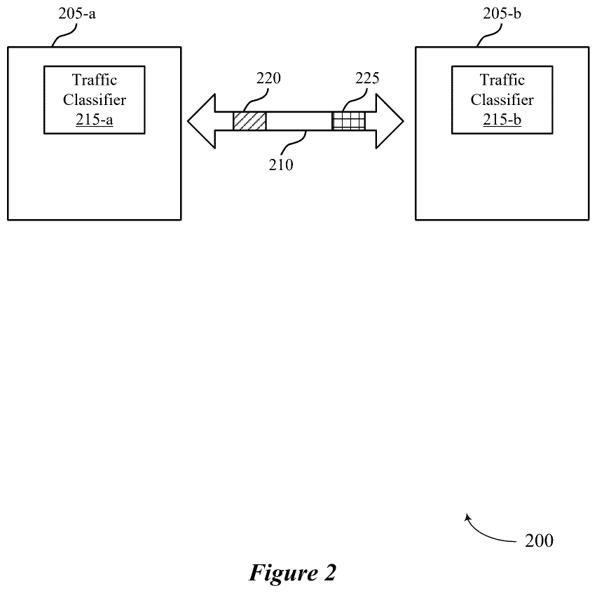

FIG. 2 shows an example of a signaling diagram 200 that supports a traffic classifier for service aware Wi-Fi operation. The signaling diagram 200 may include communications 210 between a first wireless communication device 205-a and a second wireless communication device 205-b. In some examples, each wireless communication device 205 may be an example of an AP 102 or a STA 104, as illustrated by and described with reference to FIG. 1. For example, the first wireless communication device 205-a may be a first STA 104 and the second wireless communication device 205-b may be a second STA 104. In some examples, the first wireless communication device 205-a may be a first STA 104 and the second wireless communication device 205-b may be a first AP 102. In some other examples, the first wireless communication device 205-a may be a first AP 102 and the second wireless communication device 205-b may be a first STA 104. Alternatively, the first wireless communication device 205-a may be a first AP 102 and the second wireless communication device 205-b may be a second AP 102.

In some examples, the first wireless communication device 205-a and the second wireless communication device 205-b may communicate traffic 220 via the communications 210. For example, the first wireless communication device 205-a may transmit traffic 220 (such as data or information) to the second wireless communication device 205-b, or vice versa. As discussed herein, the term “communicate” or “communicating” may refer to a wireless communication device 205 outputting, obtaining, transmitting, and/or receiving information, or signaling, to/from another wireless communication device 205, the wireless communication device 205 itself, or both. For example, one or more components of the wireless communication device 205 may communicate with one or more other components of the wireless communication device 205. Additionally, or alternatively, one or more components of the wireless communication device 205 may communicate with another wireless communication device 205.

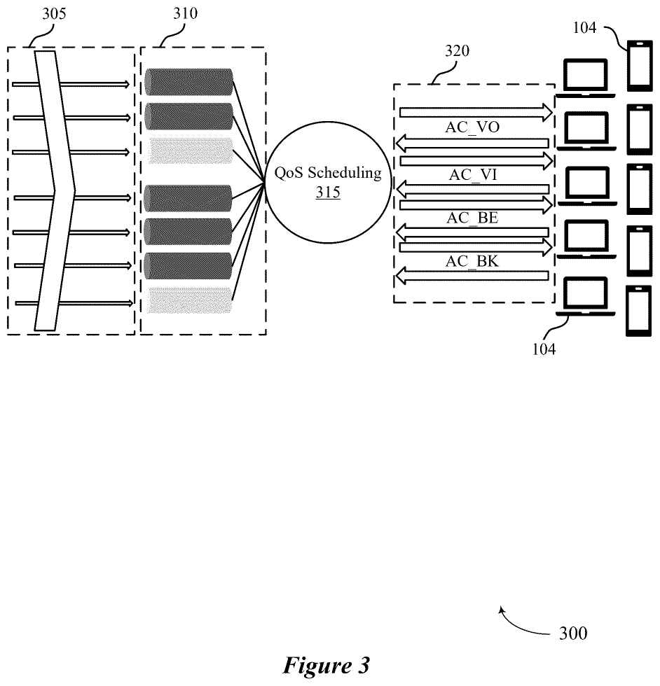

In some examples, as described further with reference to FIG. 3, a wireless communication device 205 may receive the traffic 220 in accordance with QoS scheduling and one or more channel access schemes. In some examples, the one or more channel access schemes may be applied to the traffic 220 based on a classification, or type, of the traffic 220.

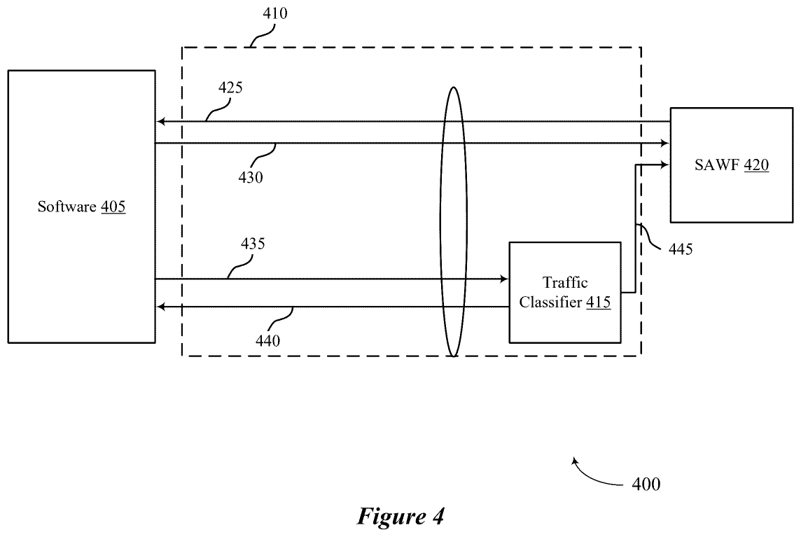

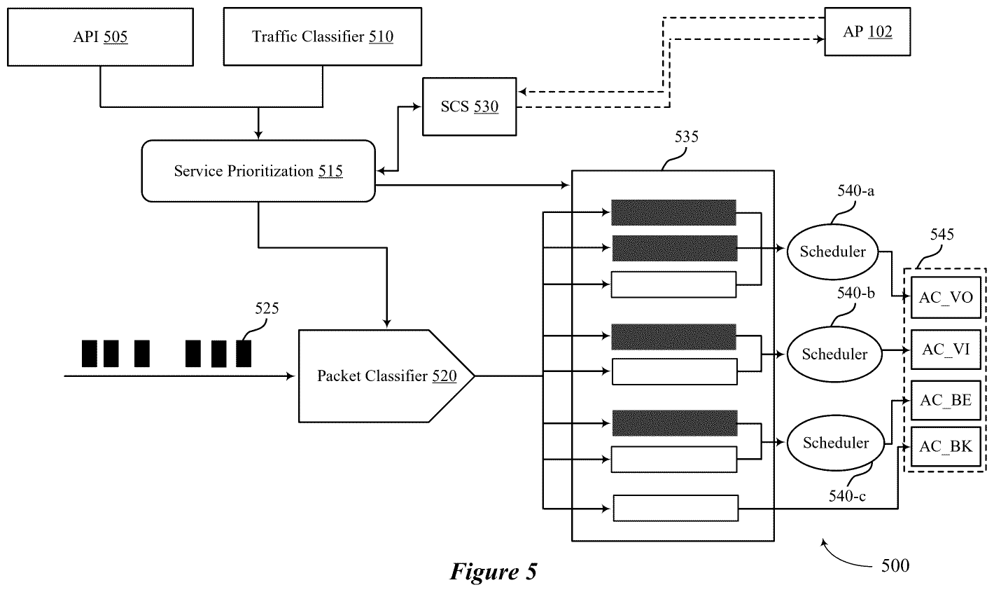

In some examples, each of the wireless communication devices may include a traffic classifier 215 that may detect the traffic type and characteristics of the traffic 220. For example, the first wireless communication device 205-a may include a first traffic classifier 215-a, and the second wireless communication device 205-b may include a second traffic classifier 215-b. As described in further detail with reference to FIGS. 4 and 5, an AP 102 and a STA 104 may each implement a traffic classifier 215.

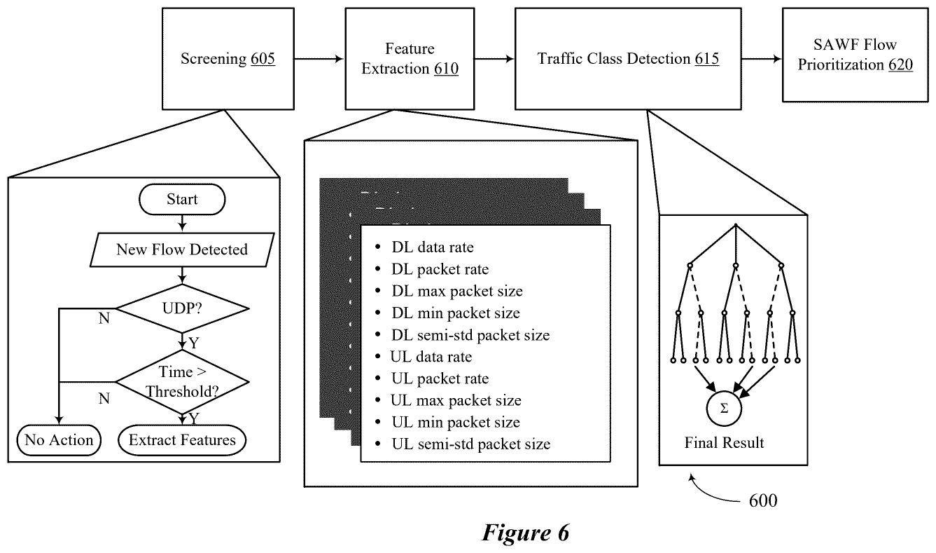

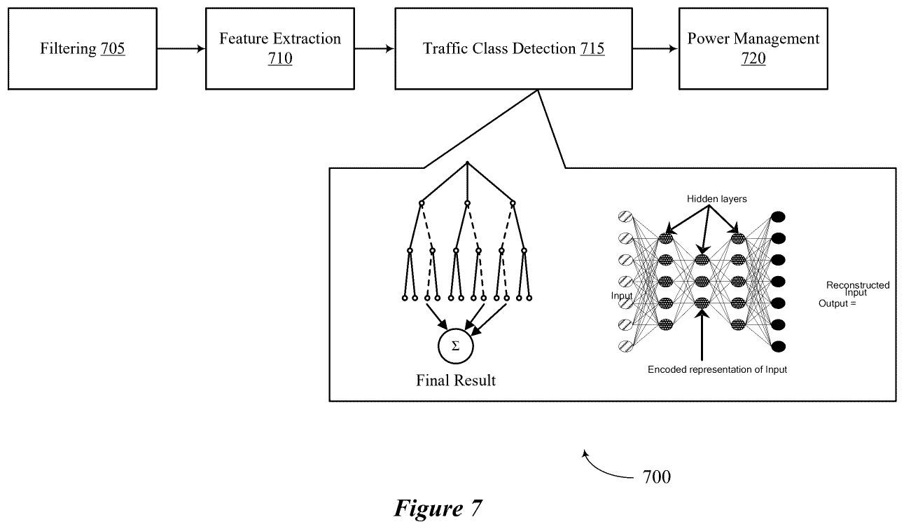

Each of the traffic classifiers 215 may detect the traffic type and characteristics based on one or more processes (such as screening, feature extraction, class detection, and flow prioritization), as described with reference to FIG. 6. Additionally, or alternatively, the traffic classifiers 215 may support power saving operations based on the detected traffic type and characteristics as described with reference to FIG. 7.

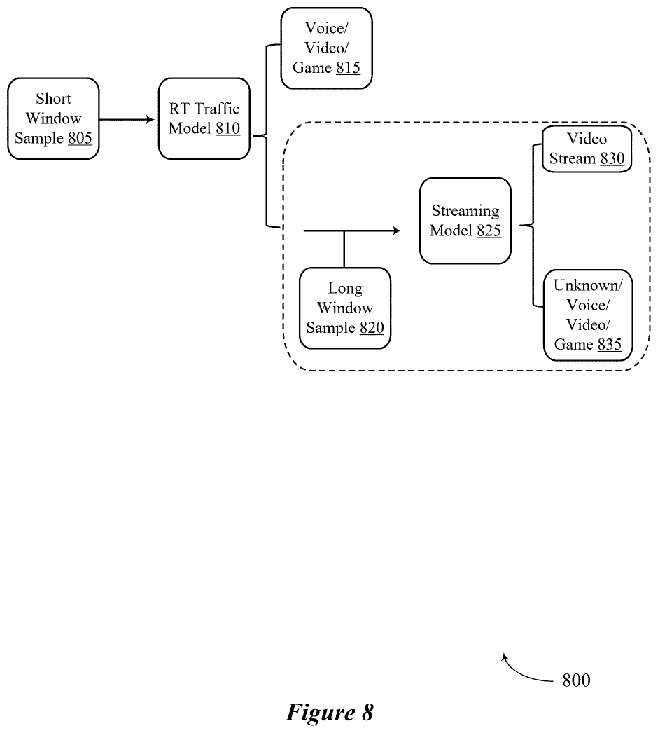

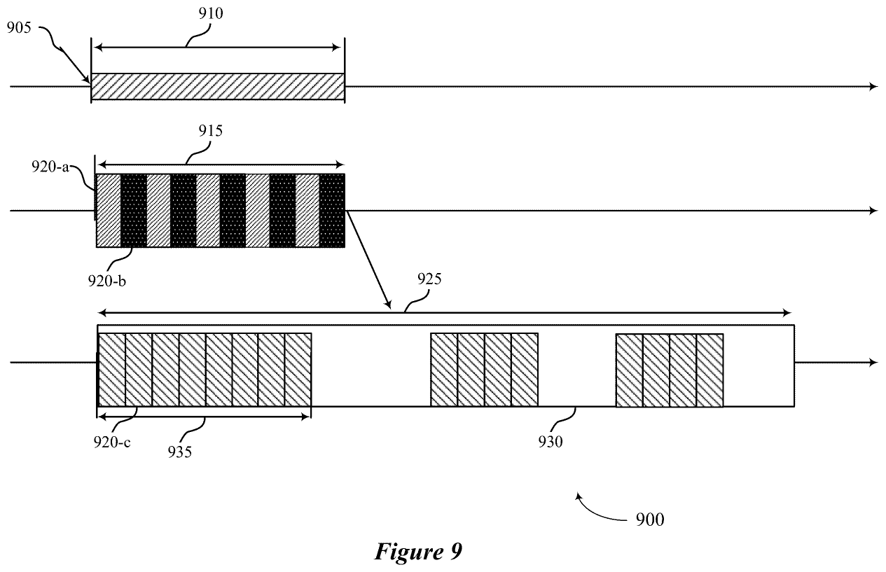

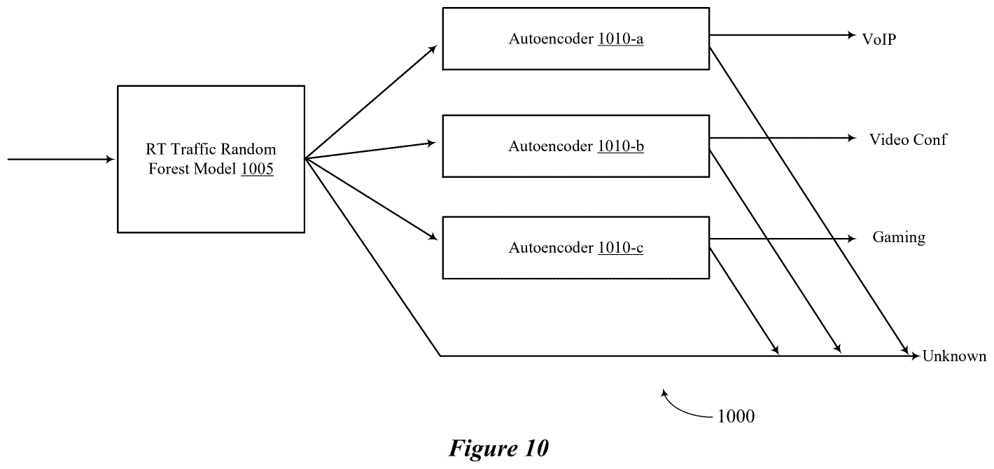

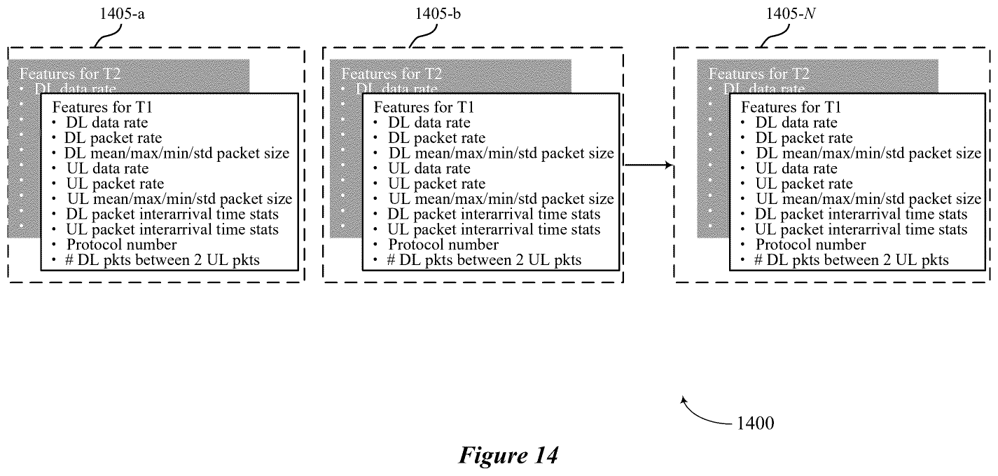

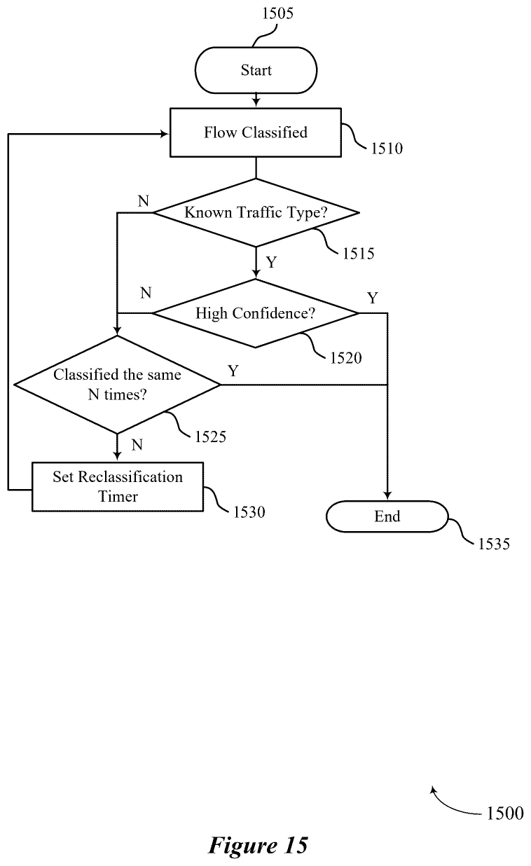

In some examples, each traffic classifier 215 may detect the traffic types based on a combination of a real-time traffic model and a streaming traffic model, as described in further detail with reference to FIGS. 8 and 9. Additionally, or alternatively, the traffic classifiers 215 may use a combination of a random forest model and one or more autoencoders that correspond to a respective traffic type, as described with reference to FIGS. 10-13. In some examples, the traffic classifiers 215 may obtain traffic characteristics from the traffic 220, which may enable the wireless communication devices 205 to configure SLA for different traffic flows. As described with reference to FIG. 14, the traffic classifiers 215 may obtain the traffic characteristics via one or more samples of the traffic 220. In some examples, the traffic classifiers 215 may verify the traffic classification via a reclassification flow, as described with reference to FIG. 15.

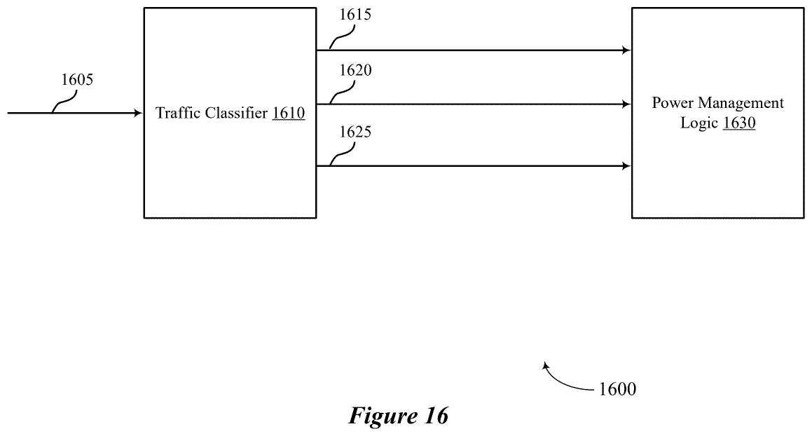

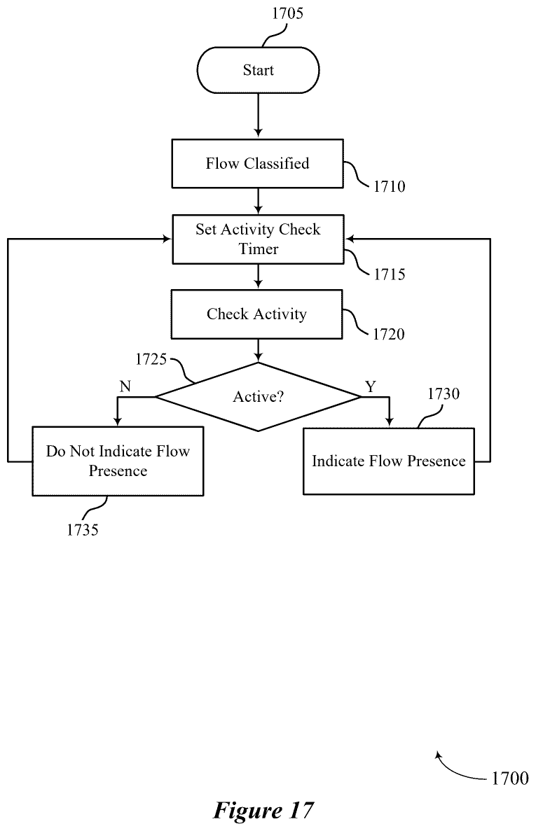

Additionally, or alternatively, each of the wireless communication devices 205 may enable one or more power saving operations based the traffic detection results of each of the traffic classifiers 215. For example, as described further with reference to FIG. 16, the traffic classifier results may enable power management logic that enables one or more power saving operations. In some examples, different types of traffic 220 may be more suitable for power saving operations (such as non-streaming traffic). Thus, as described with reference to FIG. 17, the traffic classifiers 215 may periodically check the traffic flow presence to enable or disable the power saving operations.

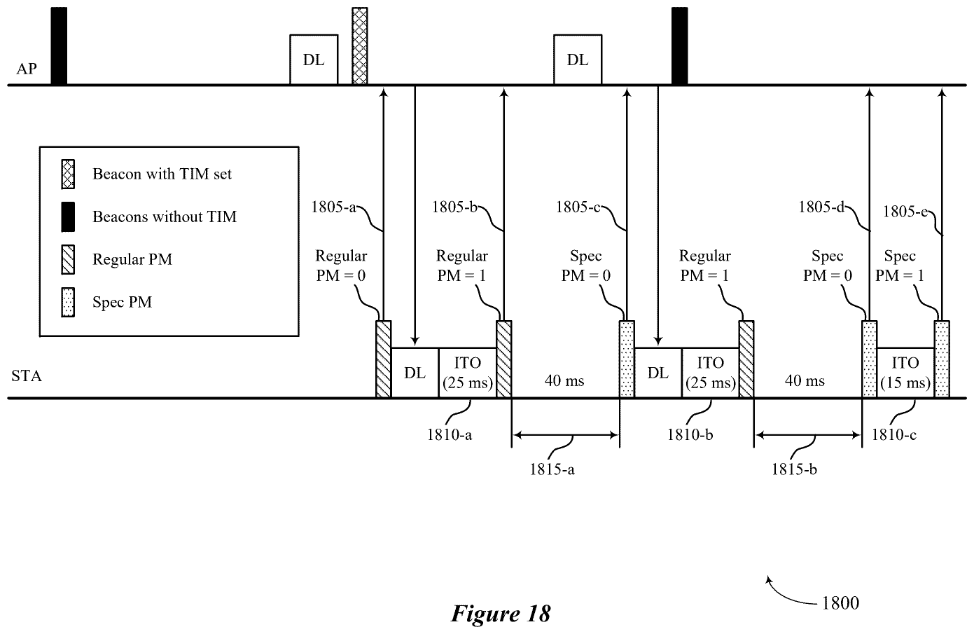

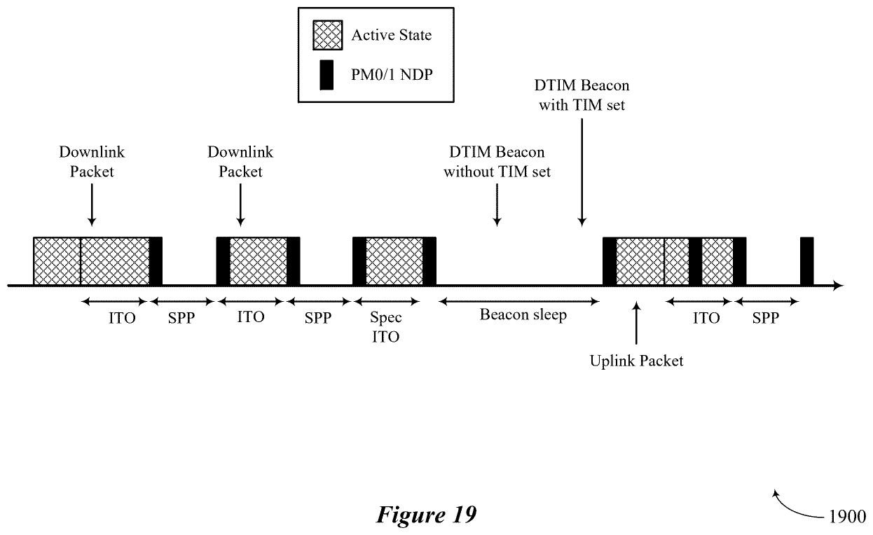

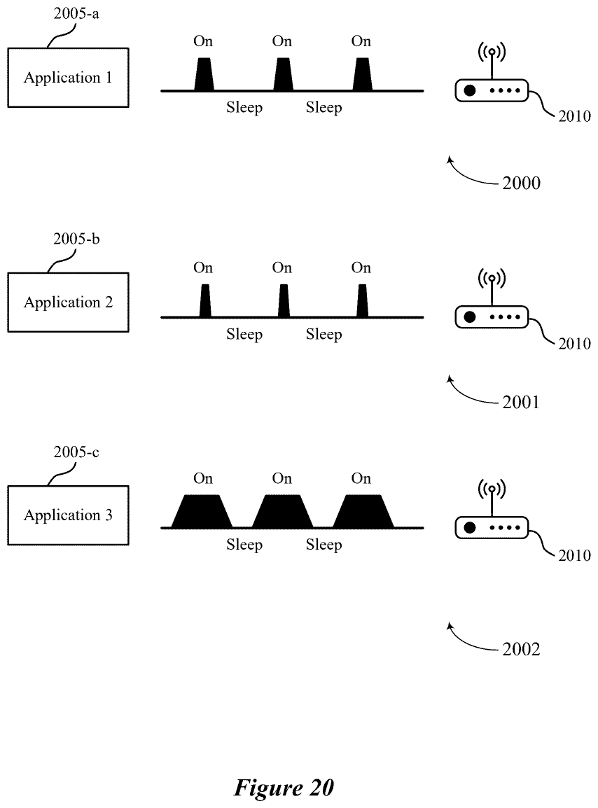

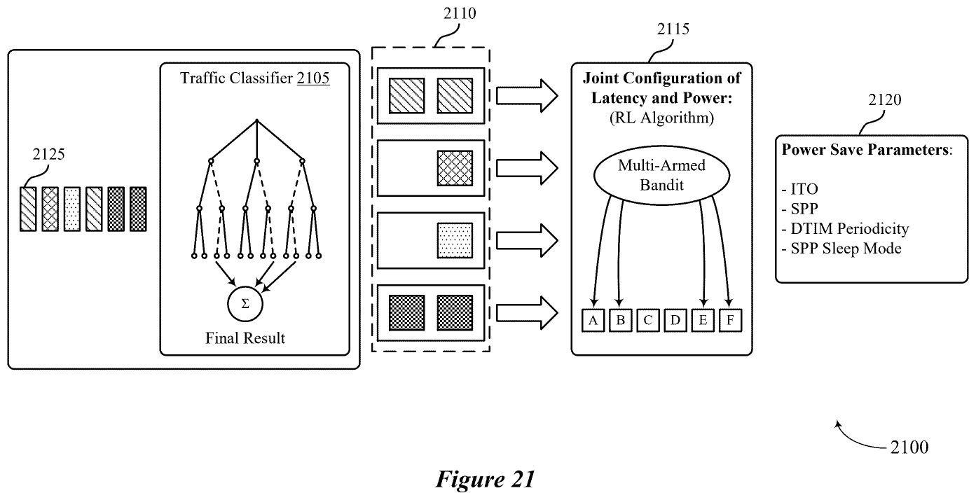

In some examples, the first wireless communication device 205-a and the second wireless communication device 205-b may exchange one or more signaling frames 225. As described further with reference to FIGS. 18 and 19, the one or more signaling frames 225 may be associated with power transitions (such as from awake to asleep, or asleep to awake) for a respective wireless communication device 205. For example, the first wireless communication device 205-a and the second wireless communication device 205-b may support periods of activity (awake) and inactivity (asleep) based on different applications and traffic 220 associated with the different applications, as discussed with reference to FIG. 20. As described further with reference to FIGS. 21-24, the output of the traffic classifiers 215 may inform each respective wireless communication device 205 in the selection of power save parameters for power transitions (such as in the selection of power save parameters for entering or exiting sleep).

FIG. 3 shows an example of a service aware Wi-Fi architecture 300 that supports a traffic classifier for service aware Wi-Fi operation. FIG. 3 illustrates an example of a SAWF providing QoS to multiple STAs 104. For example, the SAWF may receive a classified traffic flow 305 (such as streaming, video, and the like). The classified traffic may enter one or more flow queues 310. In some examples, the flow queues 310 may include one or more QoS criteria (such as QoS requirements). Based on the one or more flow queues 310, the traffic may be scheduled via QoS scheduling 315. The traffic may be scheduled in accordance with one or more channel access schemes 320 and may be directed (provided) to one or more STAs 104.

In some other wireless communication systems SAWF may not support the capability of detecting traffic type, identifying characteristics, or both (hence the QoS criteria in the one or more flow queues 310). For example, DPI may include matching packet content to application using static rules. However, some applications may increasingly use security protocols (such as HTTPS, SSH, SSL, or the like) to guarantee user privacy, which may not be supported by DPI. Additionally, or alternatively, high-volume traffic (such as 10+ Gbps) flowing through SAWF may introduce high complexity and hardware cost in real-time inspection and classification.

As described herein, ML-based traffic classification may include learning temporal and frequency characteristics of application-generated traffic (such as no deep packet inspection, hence less CPU cycles). ML-based traffic classification may obviate per-packet inspection (have lower cost compared to DPI), be agnostic to encryption, and have robust performance.

Orthogonal frequency-division multiple access (OFDMA), multiuser-multiple input multiple output (MU-MIMO), and scheduled access technologies may utilize the one or more channel access schemes 320. The one or more channel access schemes 320 may correspond to different transmission priorities. For example, a background access category (AC_BK) may be associated with a low priority, whereas a voice access category (AC_VO) may be associated with a high priority (such as relative to AC_VO). Most applications may use a best effort access category (AC_BE). ML-based traffic classification may support more efficient use of the multiple access categories.

FIG. 4 shows an example of a traffic classifier architecture on an AP 400 that supports a traffic classifier for service aware Wi-Fi operation. FIG. 4 illustrates high level architecture of SAWF on an AP with a traffic classifier 415. The AP may be an example of the AP 102 as described with reference to FIG. 1. The traffic classifier architecture on the AP 400 may include software 405 (such as customer software) that interfaces with SAWF 420 via one or more application programming interfaces (API) 410.

In some examples, the software 405 may obtain telemetry of classified flows 425 (such as traffic flows) from the SAWF 420. Based on receiving the telemetry of classified flows 425, the software 405 may output one or more de-prioritized classified flows 430 to the SAWF 420. Additionally, or alternatively, the software 405 may output an indication 435 to enable or disable the traffic classifier 415. In some examples, the software 405 may obtain one or more classification results 440 (such as traffic classification results) from the traffic classifier 415. The traffic classifier 415 also may output an indication of service prioritization 445 to the SAWF 420.

The traffic classifier 415 may include a combination of a random forest ML model and a time domain autoencoder to implement ML-based traffic classification. For example, the traffic classifier 415 may utilize the random forest ML model and the time domain autoencoder to output the one or more classification results 440. In some examples, the one or more API 410 may enable and disable the traffic classifier 415 (such as based on receiving the indication 435). The one or more API 410 may provide customer visibility to traffic classifier decisions and telemetry information of classified flows (such as the telemetry of classified flows 425). In some examples, the AP may adjust service prioritization decision of a classified flow. For example, the AP may adjust the service prioritization based on the SAWF 420 obtaining the indication of service prioritization 445.

FIG. 5 shows an example of a traffic classifier architecture on a STA 500 that supports a traffic classifier for service aware Wi-Fi operation. FIG. 5 illustrates high level architecture of SAWF on a STA with a traffic classifier 510. The STA may be an example of a STA 104, as described with reference to FIG. 1. In some examples, an API 505 (such as a customer API for service prioritization) and the traffic classifier 510 may install service prioritization policies into a service prioritization module 515. The service prioritization module 515 may install one or more classifiers (such as IP tuple based, DSCP based) in a packet classifier 520. The packet classifier 520 may receive one or more packets 525 and may classify the one or more packets 525 in accordance with the classifiers installed by the service prioritization module 515. In some examples, the packet classifier 520 may output classified packet information to one or more flow queues 535.

Additionally, or alternatively, the service prioritization module 515 may communicate with the SCS 530 and the one or more flow queues 535 to provision one or more MSDU queues, install one or more QoS, or both. In some examples, the SCS 530 may output an SCS request for downlink and uplink flows to an AP 102. The AP 102 may be an example of an AP 102 as described with reference to FIG. 1. The AP 102 may output a DSCP policy request for uplink flows to the SCS 530.

In some examples, the one or more flow queues 535 may output traffic (such as traffic associated with the one or more packets 525) to one or more schedulers 540. The one or more schedulers 540 may schedule the traffic in accordance with one or more channel access schemes 545. For example, scheduler 540-a may schedule traffic in accordance with a voice access category, scheduler 540-b may schedule traffic in accordance with a video access category, and scheduler 540-c may schedule traffic in accordance with a best effort category.

The traffic classifier 510 may include a combination of a random forest ML model and a time domain autoencoder to implement ML-based traffic classification. The traffic classifier 510 on the STA may include an AIML model trained based on traffic patterns shared between the STA and an AP (such as an AP with a traffic classifier). In some examples, the API 505 (such as customer API) may enable and disable the traffic classifier 510. The API 505 may provide customer visibility to traffic classifier decisions and telemetry information of classified flows. In some examples, the AP 102 may adjust service prioritization decision of a classified flow.

FIG. 6 shows an example of a traffic type detection procedure 600 that supports a traffic classifier for service aware Wi-Fi operation. FIG. 6 illustrates an example of a basic traffic type detection procedure. For example, the traffic type detection procedure may include a screening step 605, a feature extraction step 610, a traffic class detection step 615, and a SAWF flow prioritization step 620. In some examples, the screening step 605 may include a decision flow to extract features (such as from traffic samples) based on a user datagram protocol (UDP) and a live time duration threshold. For example, based on detecting a new flow (such as a new IP 5-tuple flow), the screening step 605 may determine whether a UDP is present or not. If not, the screening step 605 may take no action. If the UDP is present, the screening step 605 may proceed to determine whether a live time is greater than a threshold. In some examples, the threshold may be a minimum duration (such as in seconds). If the live time is greater than the threshold, the screening step 605 may proceed to the feature extraction step 610. If the live time does not satisfy the threshold (is less than the threshold), the screening step 605 may take no action.

The feature extraction step 610 may include the extraction of one or more parameters associated with the transmission packets and data. The one or more parameters may include a data rate, packet rate, maximum packet size, minimum packet size, or a semi-std packet size. The one or more parameters may be associated with uplink, downlink, or both. For example, in a 600 ms window, the feature extraction step 610 may extract ten samples of features of the window including a downlink data rate and an uplink data rate, among other parameters.

In some examples, a traffic classifier may perform the traffic class detection step 615 based on the feature extraction step 610. The traffic class detection step 615 may include a random forest ML model, a time domain autoencoder, or a combination thereof. Based on the traffic class detection, the traffic may be given an access category in the SAWF flow prioritization step 620.

FIG. 7 shows an example of a block diagram 700 that supports a traffic classifier for service aware Wi-Fi operation and power saving operations. The block diagram 700 may be implemented by a traffic classifier at a wireless communication device, such as a client device (such as a STA). For example, as illustrated in the example of the block diagram 700, the traffic classifier may identify and classify traffic flows at the wireless communication device. The identification and classification of traffic flows may include one or more of the steps illustrated in the example of the block diagram 700. For example, the traffic classifier may filter (such as prune) traffic flows in a filtering step 705, extract features of identified traffic flows in a feature extraction step 710, input the extracted features to a traffic class detection model (such as including a random forest model and/or an autoencoder) in a traffic class detection step 715, and use the output of the traffic class detection model to perform power management in a power management operation 720 (such as a power saving operation). In other words, the traffic classifier may classify identified traffic flows via the filtering step 705, feature extraction step 710, and/or traffic class detection step 715, and the classified traffic flows may be input to a power management operation 720 (such as optimized power management (OPM)). The wireless communication device may perform the power management operation 720 in accordance with the classified traffic flows.

In some examples, the traffic classifier may include or be associated with the random forest model, which may be an example machine learning algorithm. In some aspects, a random forest may be understood as an ensemble learning algorithm that uses a collection of decision trees to make predictions. The multiple decision trees may be created using different random subsets of data and characteristics. Each decision tree may provide an opinion on how to classify the traffic flow to a specific traffic class. In some aspects, predictions are made by the traffic classifier (and, likewise, by a wireless communication device) by calculating the prediction for each decision tree and selecting the most popular result as the output. Thus, in some aspects, an output of the traffic classifier may be a most popular or common classification result obtained by the traffic classifier (such as by the random forest). Thus, the traffic classifier may take, as inputs, one or more traffic flows and may classify each of the one or more traffic flows into a set of one or more different traffic classes. In some aspects, different traffic classes may be associated with different latency constraints per flow. In some aspects, latency constraints may include added latency due to power save. The traffic classifier may be implemented in a host software.

FIG. 8 shows an example of a model for traffic detection 800 that supports a traffic classifier for service aware Wi-Fi operation. FIG. 8 illustrates an example of a combination of separate artificial intelligence and/or machine learning (AIML) models for real-time (RT) traffic detection and streaming traffic detection. Real-time traffic may be associated with a relatively short window sample 805 and streaming traffic may be associated with a relatively long window sample 820. For example, a model for real time traffic (such as voice, video call, or game) may use statistics within a 1.2 second window sample (such as the short window sample 805) to detect real time traffic. As a demonstrative example, given five samples for detection, the final detection time may be 6 seconds. The short window sample 805 may be input into a RT traffic model 810. The RT traffic model 810 may determine the type of traffic. For example, the RT traffic model 810 may determine voice/video call/game traffic 815 based on the short window sample 805.

In some examples, the RT traffic model 810 may determine the traffic is not real-time traffic. In such examples, a streaming traffic model 825 may be used. The streaming traffic model 825 may use statistics within a 30 s long window (such as the long window sample 820) to differentiate video streaming from other traffic. For example, the streaming traffic model 825 may differentiate video streaming traffic 830 from other traffic such as voice, video call, gaming, or some other traffic 835.

FIG. 9 shows an example of a traffic flow 900 that supports a traffic classifier for service aware Wi-Fi operation. FIG. 9 illustrates an example of multiple traffic class detection elements in a wireless device (such as an AP, client, or both). For example, a new traffic may be detected at 905, and may be monitored (by an operating system to determine whether the flow is still alive) for a duration 910 according to a TCP protocol. Based on determining the flow is still active over the duration 910, the wireless device may initiate real-time interactive traffic detection 915 (such as VOIP, video conference, gaming, and the like).

An AP or client may perform real-time interactive traffic detection 915 using a short double-sampling window for packet statistics and feature extraction from one or more samples 920. In some examples, the short double-sampling window may span one sample, such as a first sample 920-a. In some other examples, the short double-sampling window may span two samples, such as the first sample 920-a and a second sample 920-b.

In some examples, the traffic may be streaming traffic associated with a different traffic pattern than real-time traffic. For example, the AP or client may determine the traffic flow is not real time interactive traffic based on the one or more samples 920 (via multiple samples voting). In such examples, the AP or client may detect the downlink streaming traffic via downlink streaming detection 925, and may use a relatively large sampling window 930 for burst statistics and packet statistics feature extraction. In some examples, the relatively large sampling window 930 may span more than two samples (such as including two or more third samples 920-c). For example, the downlink streaming detection 925 may include a busy period 935 for slot-based traffic statistics feature extraction. In some examples, the AP or client may detect the multiple traffic classes (such as real-time, streaming, or other) using a traffic classifier.

FIG. 10 shows an example of a real-time traffic block diagram 1000 that supports a traffic classifier for service aware Wi-Fi operation. FIG. 10 illustrates an example of real-time interactive traffic detection. In some examples a traffic classifier may include a combination of a real-time traffic random forest model 1005 and one or more autoencoders 1010. The real-time traffic random forest model 1005 may identify whether real-time traffic flows are voice, video conference, gaming, or background traffic flows. While voice, video conference, gaming, and background traffic flows are illustrated in the example of FIG. 10, it may be understood that the real-time traffic random forest model may group the traffic flows into additional groups.

The combination of the real-time traffic random forest model 1005 and the one or more autoencoders 1010 may receive a sample of ML features and detect real-time traffic (such as VoIP, video conference, gaming, or other). In some examples, the real-time traffic random forest model 1005 may input identified traffic flows into respective autoencoders 1010 for respective traffic flow types. For example, the real-time traffic random forest model 1005 may identify a first traffic flow as a voice traffic flow and, accordingly, input the voice traffic flow into autoencoder 1010-a that corresponds to voice traffic. In some examples, autoencoder 1010-b may correspond to video conference traffic, and autoencoder 1010-c may correspond to gaming traffic. The one or more autoencoders 1010 may confirm the identification made by the real-time traffic random forest model 1005 or, otherwise, reclassify the traffic flow into an unknown category. For example, the autoencoders 1010 may enhance the pruning of unknown traffic (such as not in training samples for the traffic classifier) that may be different from a specifically trained traffic type. The combination of the real-time traffic random forest model 1005 and the autoencoders 1010 is one illustrative example. The real-time traffic random forest model 1005 and autoencoders 1010 may be combined in other ways not illustrated in FIG. 10 to achieve the same result of real-time interactive traffic detection.

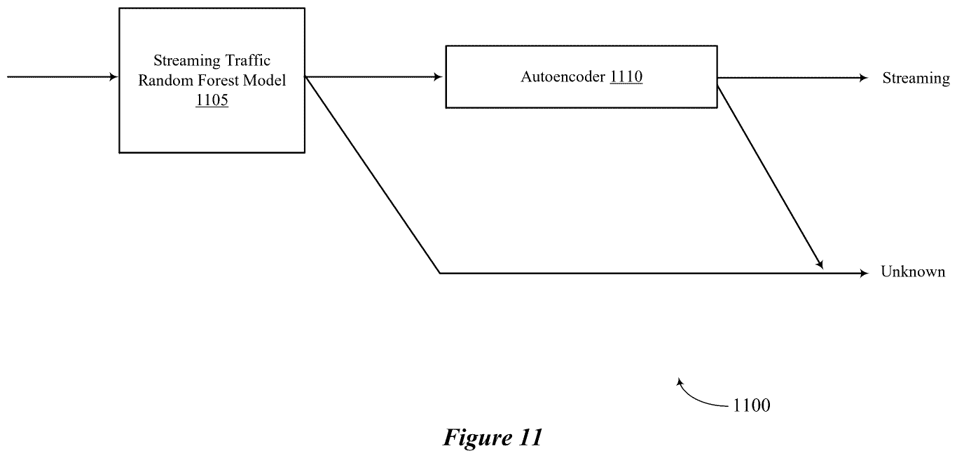

FIG. 11 shows an example of a streaming traffic block diagram 1100 that supports a traffic classifier for service aware Wi-Fi operation. FIG. 11 illustrates an example of streaming traffic detection. In some examples a traffic classifier may include a combination of a streaming traffic random forest model 1105 and one or more autoencoders 1110. The streaming traffic block diagram 1100 may identify whether streaming traffic flows are streaming or background traffic flows. While streaming and background traffic flows are illustrated in the example of FIG. 11, it may be understood that the streaming traffic random forest model may group the traffic flows into additional groups.

The combination of the streaming traffic random forest model 1105 and the one or more autoencoders 1110 may receive a sample of ML features and detect streaming traffic. In some examples, the sample of ML features may be considered unknown from the real-time traffic random forest model 1005 described with reference to FIG. 10. In some examples, the streaming traffic random forest model 1105 may input identified traffic flows into respective autoencoders for respective traffic flow types. For example, the streaming traffic random forest model 1105 may identify a first traffic flow as a streaming traffic flow and, accordingly, input the streaming traffic flow into autoencoder 1110 for streaming traffic. The respective autoencoders 1110 may confirm the identification made by the streaming traffic random forest model 1105 or, otherwise, reclassify the traffic flow into an unknown category. The combination of the streaming traffic random forest model 1105 and the autoencoders 1110 is one illustrative example. The streaming traffic random forest model 1105 and autoencoders 1110 may be combined in other ways not illustrated in FIG. 11 to achieve the same result of streaming traffic detection.

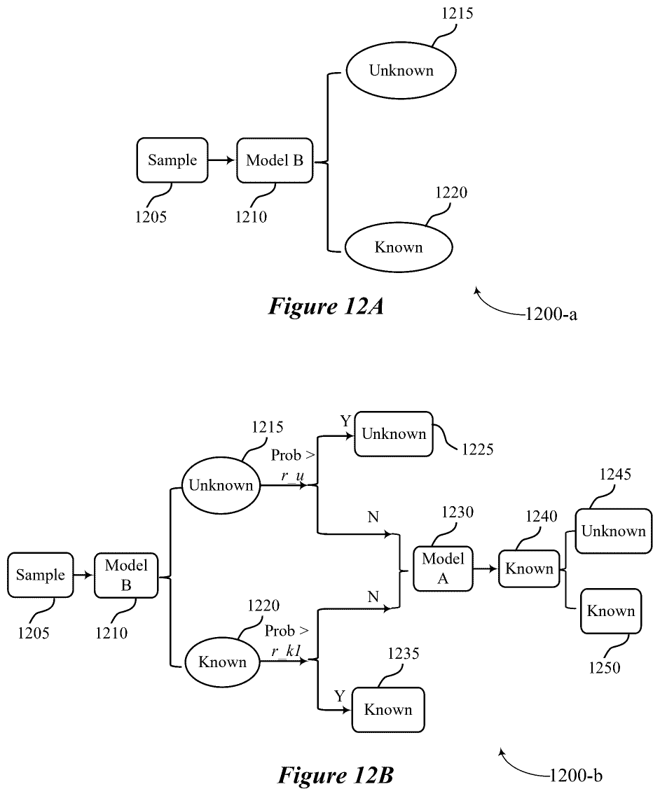

FIGS. 12A and 12B show examples of random forest model schema 1200-a and 1200-b that supports a traffic classifier for service aware Wi-Fi operation. For example, FIG. 12A illustrates an example of a one-stage random forest model scheme 1200-a and FIG. 12B illustrates an example of a two-stage random forest model scheme 1200-b. A random forest model may output a likelihood of a sample corresponding to a label. For example, a random forest model may receive a sample 1205 (such as a sample of traffic) and determine whether the sample 1205 is known or unknown to the model (such as known traffic or unknown traffic). In some examples, the random forest model may determine whether the sample 1205 is known or unknown based on detecting whether one or more portions of multiple samples correspond to one or more transmission traffic types. FIG. 12A may include a model B 1210 trained to sort uninterested traffic (with unknown type). For example, the model B 1210 may be a random forest model that is trained with non-real-time traffic and non-streaming traffic. If model B 1210 may categorize the traffic as known traffic 1220 and unknown traffic 1215 based on the sample 1205.

The random forest model scheme 1200-b may add onto the random forest model scheme 1200-a to become a two-stage random forest model. For example, FIG. 12B may include model B 1210 and a model A 1230, where the model A 1230 may be trained to sort interested traffic. After categorizing traffic as unknown traffic 1215 and known traffic 1220, the two-stage random forest model may further categorize the traffic. For example, the two-stage random forest model may determine whether a probability (of certainty) of the unknown traffic 1215 satisfies a first threshold (is greater than r_u). If the probability satisfies the first threshold, the traffic is categorized as unknown traffic 1225. If the probability does not satisfy the first threshold, the traffic may be input to model A 1230.

Additionally, or alternatively, the two-stage random forest model may determine whether a probability of the known traffic 1220 satisfies a second threshold (such as is greater than r_k1). If the probability satisfies the second threshold, the traffic may be categorized as known traffic 1235. If the probability does not satisfy the second threshold, the traffic may be input to model A 1230. For example, the model A 1230 may be a random forest model that is trained with real-time traffic and streaming traffic without unknown type.

The model A 1230 may determine whether the traffic is known traffic 1240, and the model A 1230 may categorize the traffic as unknown traffic 1245 or known traffic 1250. Each of the unknown or known traffic categories may further differentiate the traffic type based on satisfying one or more thresholds. For example, traffic may be unknown traffic 1245 based on a probability satisfying a third threshold (less than r_k2). Traffic may be known traffic 1250 based on satisfying a fourth threshold (greater than r_k2). In some examples, a combination of model B 1210 and model A 1230 may improve detection of interested traffic and non-interested traffic.

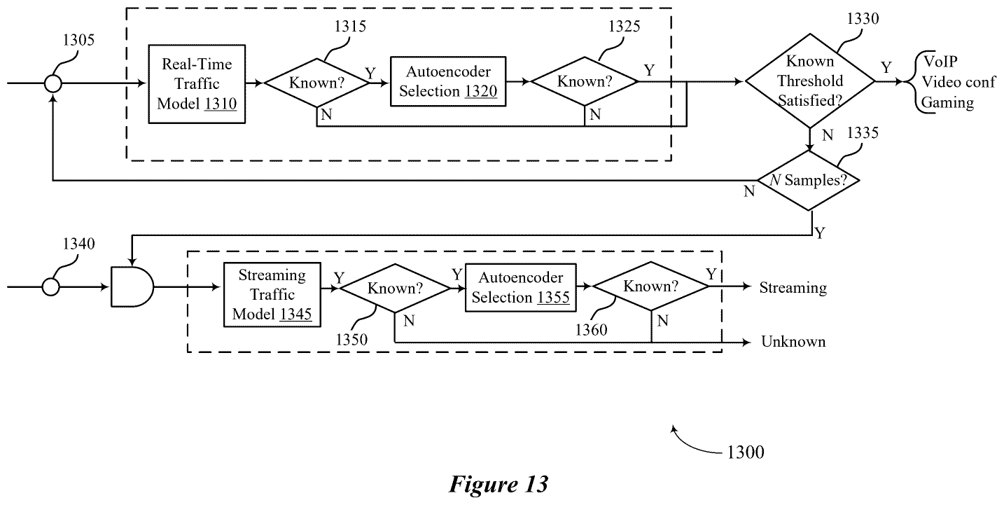

FIG. 13 shows an example of traffic detection logic 1300 that supports a traffic classifier for service aware Wi-Fi operation. FIG. 13 illustrates an example of combined AIML model detection logic. For example, a traffic classifier may include multiple random forest models, such as a real-time traffic model 1310 and a streaming traffic model 1345, as well as autoencoders. The traffic classifier may sample traffic using a short window sample 1305 and may detect whether the traffic is associated with real-time traffic, streaming traffic, or another type of traffic. For example, the one short window sample 1305 may be input into the real-time traffic model 1310 which may determine whether the traffic associated with the one short window sample 1305 is known at 1315 (such as known traffic such as VoIP, video conference, gaming, and the like). If the traffic is not known, the real-time traffic model 1310 may categorize the traffic as unknown. If the traffic is known, an autoencoder corresponding to the known traffic type may be selected via the autoencoder selection 1320. For example, known gaming traffic may be input to a gaming autoencoder. The selected autoencoder may determine whether the traffic is known or unknown at 1325 (such as whether the gaming traffic is known or unknown).

Based on the traffic being determined as known or unknown at 1325, the traffic detection logic 1300 may determine whether the traffic is detected as a known class (traffic type) for an M threshold quantity of times at 1330. For example, if the gaming traffic is detected as known M times, the traffic may be categorized as gaming traffic. If not, the traffic detection logic 1300 may determine whether N quantity of samples were used at 1335. If not, the traffic may be input to the beginning of the logic flow at the real-time traffic model 1310. If so, the traffic may be combined with a long window sample 1340, and the traffic may be input to the streaming traffic detection logic which uses a relatively longer window sample.

For example, the traffic may be input into streaming traffic model 1345. The streaming traffic model 1345 may determine whether the traffic is known (such as known streaming traffic) or not at 1350. If the traffic is determined to be unknown, the traffic may be categorized as unknown traffic. If the traffic is determined to be known, an autoencoder corresponding to the known traffic type may be selected at 1355. The selected autoencoder may further determine whether the traffic is known or unknown at 1360. If the traffic is known, it may be categorized as streaming traffic (and if unknown, categorized as unknown traffic).

FIG. 14 shows examples of traffic classifier features 1400 that support a traffic classifier for service aware Wi-Fi operation. FIG. 14 illustrates examples of AIML traffic classifier features. A traffic classifier may be associated with or implement an artificial intelligence (AI) and/or machine learning (ML) model. The traffic classifier may collect one or more samples 1405 over one or more sampling windows. For example, the traffic classifier may collect a packet log of N samples (such as N=5 samples including a first sample 1405-a and a second sample 1405-b). As an example, the traffic classifier may collect the N samples for an IP 5-tuple flow (up to Nth sample 1405-N). Each sample may include packet information (such as statistics, features) over a double sampling window of duration T1 and T2 (such as T1=300 ms, T2=1.2 s). That is, the traffic classifier may collect features for the first sample 1405-a over at least a first duration (T1) and a second duration (T2), where the first sample 1405-a includes features associated with the first duration and the second duration (such as for real-time interactive traffic). While the traffic classifier is illustrated as collecting samples over a double sampling window (such as the first duration and the second duration), it may be understood that the traffic classifier may collect the samples over fewer than or greater than two windows.

For example, the packet information may include burst statistic features and/or packet statistic features (for downlink streaming traffic). The burst statistic features may include a burst duration (minimum, maximum, average), a burst size (minimum, maximum, average), and/or a burst count (quantity). The packet statistic features may include a packet size (minimum, maximum, average), a packet interval time (minimum, maximum, average), a packet rate, a data rate, a quantity of packets per slot in a busy period (minimum, maximum, average), and/or a quantity of bytes per slot in a busy period (minimum, maximum, average).

FIG. 15 shows an example of a reclassification flow 1500 that supports a traffic classifier for service aware Wi-Fi operation. FIG. 15 illustrates an example of a traffic classifier enhancement for reclassification. A traffic classifier may attempt to classify traffic. For example, the traffic classifier may reclassify traffic associated with a first traffic classification, classify traffic unassociated with a traffic classification, or both, beginning at 1505.

In some examples, the traffic classifier may perform reclassification attempts. As an example, the traffic classifier may perform the reclassification attempts when a flow is classified as real-time traffic or video downlink streaming traffic at 1510 (such as classifications with low confidence compared to other traffic flows). Based on classifying the flow at 1510, the traffic classifier may determine whether the traffic type is known or not at 1515. If the traffic type is known, the traffic classifier may continue to 1520 to determine whether the traffic is classified with a high confidence or not. If the traffic type is unknown, the traffic classifier may continue to 1525 to determine whether the traffic has been classified a threshold quantity of times (such as N times). If the traffic classifier has classified the traffic the threshold quantity of times, the traffic classifier may terminate the reclassification flow 1500 at 1535. If the traffic classifier has not classified the traffic the threshold quantity of times, the traffic classifier may continue to 1530 to reclassify the traffic. For example, the traffic classifier may perform a threshold quantity of reclassification attempts (such as N times, such as N=6). The traffic classifier may perform a quantity of reclassification attempts equal to the threshold quantity of reclassification attempts.

Reclassification attempts may be separated with a timer set at 1530. For example, a first reclassification attempt may occur at a first time, and a second reclassification attempt may occur at a second time, where the first time and the second time are separated by a threshold duration. The traffic classifier may include a timer set to the threshold duration, where the timer resets after a reclassification attempt. For example, the traffic classifier may include multiple timers associated with different traffic types, such as video streaming (such as T_reclassification_interval_VideoStreaming may be 60 seconds) and/or real-time traffic (such as T_reclassification_interval_RT_traffic may be 10 seconds).

Alternatively, the traffic classifier may perform a quantity of reclassification attempts below the threshold quantity of reclassification attempts based on the classification being associated with a threshold level of confidence. That is, the traffic classifier may refrain from performing an additional reclassification attempt based on a reclassification attempt being associated with the threshold level of confidence. For example, the traffic classifier may end the reclassification flow 1500 at 1535 based on determining that the traffic was classified with a relatively high confidence at 1520. Additionally, or alternatively, the traffic classifier may reclassify the traffic (such as the packets) based on the traffic type confidence being less than or equal to the threshold level of confidence at 1520.

Additionally, or alternatively, if a flow is classified as unknown, the traffic classifier may perform the threshold quantity of reclassification attempts while the flow is classified as unknown. That is, the traffic classifier may reclassify the traffic until the flow is detected or until the quantity of reclassification attempts reaches the threshold quantity. For example, the traffic classifier may refrain from performing an additional reclassification attempt for the flow based on the flow being detected (being classified).

FIG. 16 shows an example of a block diagram 1600 that supports a traffic classifier for service aware Wi-Fi operation and power saving operations. The block diagram 1600 may be implemented by a traffic classifier at a wireless communication device, such as a client device. A traffic classifier 1610 may indicate traffic conditions under which power management may be applied at a client device.

In some examples, multiple flows may be present at a same time at a client. In other words, a client may be associated with at least a first flow for a first period of time and a second flow for a second period of time, where the first period of time and the second period of time are at least partially overlapping. Each flow may include one or more respective flow statistics 1605 (such as per flow statistics). In some examples, a client may implement power management operations based on the traffic classifier 1610 receiving the flow statistics 1605.

Power management may be applied based on a traffic type, a traffic load, or both. For example, a client may apply power management based on a traffic type being one of video downlink streaming, non-latency-sensitive traffic (such as real-time traffic), or both. For example, the power management may be applied based on a presence of video downlink streaming and/or an absence of latency-sensitive traffic. Additionally, or alternatively, a client may apply power management based on a traffic load being below a threshold (such as an unknown, background traffic load). For example, the threshold may be a traffic rate lower than R kbps, such as 300 kbps. Additionally, or alternatively, the client may apply power management based on the traffic load being below or equal to the threshold.

The traffic classifier 1610 may monitor traffic and report information associated with traffic flows. For example, the traffic classifier may track a throughput of traffic flows (such as unknown traffic flows) periodically (such as every T seconds, such as 3 seconds). Additionally, or alternatively, the traffic classifier 1610 may track the throughput of traffic flows over a previous time duration, such as a last T seconds. In some examples, the traffic classifier 1610 may output a first indication 1615 that indicates a presence of video downlink streaming, a second indication 1620 that indicates a presence of real-time traffic, a third indication 1625 that indicates a total quantity of downlink and uplink unknown traffic flow statistics, or any combination thereof. In some examples, the client may perform power management based on the power management logic 1630 obtaining one or more of the first indication 1615, the second indication 1620, or the third indication 1625. For example, the power management logic 1630 may enable power management based on receiving the one or more indications.

FIG. 17 shows an example of a flow diagram 1700 that supports a traffic classifier for service aware Wi-Fi operation and power saving operations. The flow diagram 1700 may be implemented by a traffic classifier at a wireless communication device, such as a client device. A traffic classifier may perform a flow activity check beginning at 1705. In some examples, the traffic classifier may classify the flow at 1710. Based on classifying the flow at 1710, the traffic classifier may set an activity check timer 1715.

The traffic classifier may monitor for inactivity of traffic flows periodically (such as via an activity check timer set at 1715). For example, different traffic flows may be associated with respective activity check timers at the traffic classifier. As an example, a video streaming flow may be associated with a first timer (such as T_activity_interval_VideoStreaming=10s), a real-time traffic flow may be associated with a second timer (such as T_activity_interval_RT_traffic=6s), and a background traffic flow may be associated with a third timer (such as T_activity_interval_background=6s). In other words, the traffic classifier may use a timer for activity checks. In some examples, the activity checks may check one or more activities associated with the traffic flows.

Based on an expiration of a respective activity check timer, the traffic classifier may check the activity at 1720. The traffic classifier may determine whether the traffic is active or inactive at 1725. In some examples, a traffic flow may be considered active based on a throughput being above a threshold percentage (such as 10%) of an originally detected throughput by the traffic classifier. In some other examples, a traffic flow may be inactive based on the throughput being below the threshold percentage.

The traffic classifier may indicate a traffic flow type as being present to power management based on the traffic flow being active at 1730. For example, the traffic classifier may refrain from indicating a traffic flow as being eligible for power management when the traffic flow is inactive, but indicate that the traffic flow is eligible for power management at the client based on the traffic flow becoming active (such as based on indicating the flow presence at 1730).

In some examples, the traffic classifier may refrain from indicating a presence of a detected traffic flow based on the flow becoming inactive at 1735. For example, a traffic flow may become inactive based on a user of a client device switching to a different application. In some examples, the traffic classifier may stop indicating the presence of a detected traffic flow based on an operating system of the client detecting the flow.

FIG. 18 shows an example communication timeline 1800 that supports power save parameter selection at a client device in accordance with a joint evaluation of latency and power consumption. The communication timeline 1800 illustrates communication between an AP and a STA, which may be examples of an AP 102 and a STA 104, respectively, as illustrated by and described with reference to FIG. 1. The communication timeline 1800 may be implemented by one or more APs and one or more STAs for one or both of uplink communication and downlink communication.

The communication timeline 1800 includes beacons (such as Beacon frames) without a traffic indication map (TIM) and beacons with a TIM set. In some aspects, the TIM may be an example of a delivery TIM (DTIM). A DTIM may be associated with Wi-Fi beacon assisted wakeups (with a device potentially sleeping during the rest of a duration). The power contribution (such as power or energy consumption) of DTIM and device listen operations may be approximately 55% to up to approximately 80% of a device's power. Some platforms or systems have aimed to reduce a magnitude of power consumption (which may be understood as Y-axis reduction). In other words, a Y-axis value or metric may be associated with a current power consumption of each period (such as a listen period, a DTIM period, a short sleep period, or a transmission or reception period). Additionally, or alternatively, some platforms or systems that aim to improve power savings may reduce or limit (such as configure or optimize) time spent awake or otherwise in active operation (which may be understood as X-axis reduction). In other words, an X-axis value or metric may be associated with a duration of each period (such as a duration of a listen period, a DTIM period, a short sleep period, or a transmission or reception period). Reducing or limiting (or optimizing) time spent awake may include reducing an overall listen duration or increasing overall DTIM duration (such as increasing a DTIM period) while meeting (such as satisfying) application/traffic requirements/constraints.

In some aspects, a power management (PM) component of some existing systems may use a signaling frame 1805 (which may be referred to as a safe signaling frame) for power transitions (such as for all power transitions). Such a signaling frame 1805 may be a quality of service (QOS) null data packet (NDP) with a power management (PM) bit set equal to 1 (PM=1) or 0 (PM=0). For example, a wireless communication device (such as a STA 104 or a client device) may transmit the signaling frame 1805 (such as 1805-a, 1805-b, 1805-c, 1805-d, or 1805-c) to indicate a PM status of the wireless communication device. A PM indication may be associated with or understood as a regular PM or as a speculative PM (shown as “spec PM” in the example of FIG. 18). A speculative PM may be sent by a wireless communication device if the wireless communication device would like to try to receive any downlink packets that an AP 102 may currently be buffering for the wireless communication device.

In some aspects, a wireless communication device (as or via a PM component) may use the signaling frame 1805 for speculative fetches and regular mode changes. Further, in some aspects, switching to PM=0 (such as via the QoS NDP) may allow aggregates for buffered traffic download, as opposed to a single packet fetch by a power save (PS) poll (PS-POLL) frame. In some aspects, a reduced ITO look up table may be used for speculative wakes to increase power consumption efficiency (such as to optimize power).

The communication timeline 1800 illustrates various ITO durations and various actions or operations. For example, in some aspects, an ITO 1810-a may be set to 25 milliseconds (ms). In some examples, such an ITO 1810-a duration may be a congestion metric (such as congestion value) estimated ITO. An ITO of 25 ms may be understood as a regular ITO. Further, in some examples, a wireless communication device (such as a STA) may perform a speculative fetch during an ITO 1810-b duration (such as an ITO duration of 25 ms). In some examples, an ITO may be set to 15 ms. An ITO of 15 ms may be understood as a reduced ITO. In some aspects, a wireless communication device (such as a STA) may employ, use, or otherwise communicate in accordance with a speculative mode reduced ITO during a 15 ms ITO 1810-c. During time durations (such as 40 ms time durations) between signaling frames, a wireless communication device may perform conditional (such as optional) speculation 1815 (such as such as a first conditional speculation 1815-a and a second conditional speculation 1815-b).

FIG. 19 shows an example communication timeline 1900 that supports power save parameter selection at a client device in accordance with a joint evaluation of latency and power consumption. In some aspects, the communication timeline 1900 illustrates communication between an AP and a STA, such as an AP 102 and a STA 104, respectively, as illustrated by and described with reference to FIG. 1. For example, the communication timeline 1900 illustrates communication (such as transmission or reception) of downlink packets, uplink packets, beacon frames (with or without a TIM set, such as with or without inclusion of a TIM) and NDPs (with a PM indication or bit set to 0 or 1). The communication timeline 1900 further illustrates periods of time during which a wireless communication device, such as a STA, is in an active state. Additionally, the communication timeline 1900 illustrates various time durations associated with one or more power save parameters. Such power save parameters include ITOs and SPPs, or parameters indicative of an ITO and an SPP. Such power save parameters may further include a beacon sleep interval. In some examples, the power save parameters (such as the SSP) may be greater than or equal to a delivery DTIM interval.

In some aspects, a wireless communication device may enter a “deep” sleep if there are no downlink or uplink packets for a specific timeout duration, such as for a duration of an ITO. Further, a wireless communication device may wake up at DTIM epochs to check for availability of downlink data. A DTIM epoch may be a point in time at which a beacon frame including a DTIM (such as a DTIM Beacon frame) is expected to be received. As described herein, it may be understood that an epoch (such as a time epoch, a DTIM epoch, a decision epoch, a previous epoch, etc.) may refer to a duration (such as a first duration, a second duration, a previous duration). Such beacon frames may be received according to a DTIM interval, which may be a multiple of a beacon interval, such as n*beacon interval, with a beacon interval set at, for example, 100 ms. In some aspects, a duration of an ITO and a duration of a spec ITO may be selected from multiple look up tables. Such look up tables may include a look up table associated with a Wi-Fi latency manager (WLM) (with configuration settings that include normal, moderate, low, and ultra-low latency (ULL)), a look up table associated with congestion values, or a look up table associated with a band of operation.

In some scenarios, ITO and spec ITO selection may be associated with static tables (such that SPP is not altered). Further, WLM configuration settings may not be used by most applications, leading to a normal latency table frequently being selected by a wireless communication device (even though multiple tables are expected to be maintained at the wireless communication device). Additionally, in some scenarios, sleep parameters (such as power save parameters) may not explicitly depend on the ongoing applications or incoming traffic patterns, which may result in some amount of unnecessary power consumption for at least some applications or traffic patterns.

FIG. 20 shows example sleep schedules 2000, 2001, and 2002 that support power save parameter selection at a client device in accordance with a joint evaluation of latency and power consumption. The example sleep schedules 2000, 2001, and 2002 may illustrate time periods associated with active operation (such as “on” time periods”) and time periods associated with inactivity (such as “sleep” time periods). In other words, a wireless communication device 2010 may be in an “on” state during the time periods associated with active operation and may otherwise be in an “off” or “sleep” state.

Different applications 2005 may have different sleep schedules. For example, as illustrated in the example of FIG. 20, a first application 2005-a may be associated with the sleep schedule 2000, a second application 2005-b may be associated with the sleep schedule 2001, and a third application 2005-c may be associated with the sleep schedule 2002. Data arrival in some WLANs may be dictated by (such as associated with or in accordance with) an application type (such as a traffic pattern), a congestion of the medium, or backend delays.

Further, different applications 2005 may be associated with (such as have) different latency constraints (such as different latency expectations or requirements). In some aspects, latency constraints may be in conflict with power constraints (such as power expectations or requirements). For example, for latency sensitive applications such as gaming, 100 ms of sleep may impact latency. For further example, for symmetric traffic applications such as voice over internet protocol (VOIP), 100 ms of sleep may not be feasible due to frequent interruptions by uplink traffic. Generally, a static (inflexible) trade-off between latency and power may result in network or device inefficiencies.

In accordance with some example implementations of the present disclosure, a wireless communication device may leverage an output of a traffic classifier to determine, identify, select, calculate, ascertain, or otherwise obtain information indicative of a latency constraint (such as a latency expectation, need, or requirement) of each of one or more traffic flows. The wireless communication device may use a reinforcement learning (RL) algorithm to configure (such as to optimize) in real time the latency/power trade-off. The wireless communication device also may keep track of a potentially changing environment (which may relate to or include changes associated with a latency constraint of the traffic or variations in congestion level) and changing “power cost” of different low power activities over generations (which may relate to or include listen power, S2W/W2S over-head power, or a shallow sleep power mode). In accordance with such example implementations, the wireless communication device may achieve power savings over other power save mechanisms.

In accordance with such a traffic classifier and the RL algorithm, the wireless communication device may select values for one or more power save parameters. Such power save parameters may include an ITO, an SPP, a DTIM periodicity, and a sleep mode. An ITO may relate to how long a wireless communication device listens when PM=1, and may be set to any value including 10 ms, 20 ms, 30 ms, 50 ms, 100 ms, or 200 ms. An ITO that is too small (such as 10 ms) may result in relatively lower power consumption at a potential cost of latency. An ITO that is set too large (such as 100 ms) may result in lower latency at a potential cost of power consumption. An SPP may relate to how long a wireless communication device stays in a sleep state when PM=0. An SPP may be set to any value including 10 ms, 20 ms, 30 ms, or 50 ms. Outputs related to an SPP value may include an indication of whether speculative poll is to be used, an indication of which power save mode to enter between speculative polls, or an indication of how long the SPP value should be.

A DTIM periodicity may have similar pros and cons as an ITO and may be set to any value including 100 ms, 200 ms, 300 ms, 400 ms, 500 ms, 600 ms, 700 ms, 800 ms, or 900 ms. A DTIM associated with a DTIM1 setting may correspond to a DTIM of 100 ms, a DTIM associated with a DTIM2 setting may be correspond to a DTIM of 200 ms, and so on. Thus, for example, a DTIM1 may be associated with lower latency at a potential cost of power consumption. For further example, a DTIM3 or higher may be associated with relatively lower power consumption at a potential cost of latency. A sleep mode may be indicative of light sleep (LS) or deep sleep (DS). LS may be selected when an SPP duration is relatively small. DS may be selected for relatively longer sleep periods (such as DTIM entry). For example, DS may be selected when the SPP duration is greater than or equal to a threshold SPP value.

FIG. 21 shows an example block diagram 2100 that supports power save parameter selection at a client device in accordance with a joint evaluation of latency and power consumption. The block diagram 2100 may illustrate a selection of one or more power save parameters 2120, including an ITO, an SPP, a DTIM periodicity, or a sleep mode (such as an SPP sleep mode). The block diagram 2100 may include a traffic classifier 2105 that classifies a traffic flow into a traffic class 2110 and an RL algorithm 2115 that jointly configures (such as jointly optimizes) latency and power in accordance with a result of (such as an output of) the traffic classifier 2105. An output of the RL algorithm 2115 may include information indicative of an ITO, an SPP, a DTIM periodicity, or a sleep mode (such as an SPP sleep mode).

In some examples, the traffic classifier 2105 may include or be associated with a random forest model, which may be an example machine learning algorithm. In some aspects, a random forest model may be understood as an ensemble learning algorithm that uses a collection of decision trees to make predictions. The multiple decision trees may be created using different random subsets of data and characteristics. Each decision tree may provide an opinion on how to classify the traffic flow to a specific traffic class. In some aspects, predictions are made by the traffic classifier 2105 (and, likewise, by a wireless communication device) by calculating the prediction for each decision tree and selecting the most popular result as the output. Thus, in some aspects, an output of the traffic classifier 2105 may be a most popular or common classification result obtained by the traffic classifier 2105 (such as by the random forest model). Thus, the traffic classifier 2105 may take, as inputs, one or more traffic flows 2125 and may classify each of the one or more traffic flows 2125 into a set of one or more different traffic classes 2110 (such as video, gaming, or voice). In some aspects, different traffic classes 2110 may be associated with different latency constraints per flow. In some aspects, latency constraints may include added latency due to power save. In some aspects, the traffic classifier 2105 may be implemented in a host software.

In accordance with obtaining results of the traffic classifier 2105, the RL algorithm 2115 may perform a joint configuration (such as a joint optimization) of latency and power for the various traffic classes 2110, individually or collectively. In some aspects, the algorithm may meet the latency budget for a given traffic class 2110 and, after meeting the budget, may trade-off latency for power savings. In some aspects, the RL algorithm 2115 may be implemented as a multi-armed bandit. A multi-armed bandit may be understood as an algorithm according to which a decision maker (such as a selector) iteratively selects one of multiple fixed choices (which may be understood as arms or actions) when the properties of each choice are potentially only partially known at the time of allocation, evaluation, or selection and may become better understood as time passes. The RL algorithm 2115 may be understood as an RL framework and may include or be associated with one or multiple RL models/estimators. The RL algorithm 2115 may jointly evaluate latency and power for a given traffic flow 2125 (such as in accordance with a classification of a traffic flow) and may output one or more power save parameters 2120 for the traffic flow 2125 in accordance with the joint evaluation. Such one or more power save parameters 2120 may include an ITO value, an SPP value, a DTIM periodicity, or a sleep mode (such as an SPP sleep mode).

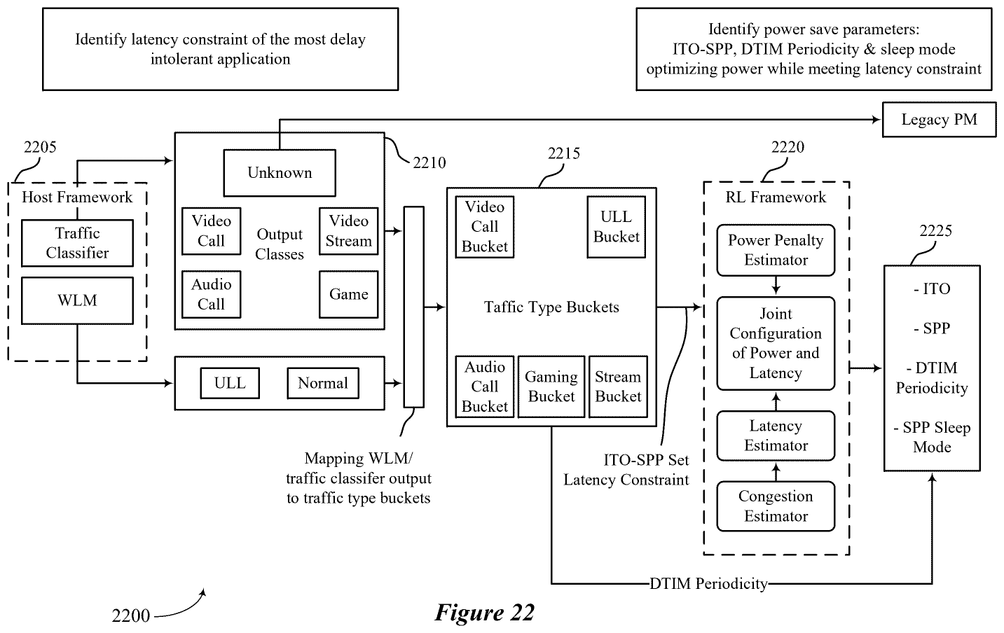

FIG. 22 shows an example block diagram 2200 that supports power save parameter selection at a client device in accordance with a joint evaluation of latency and power consumption. The block diagram 2200 may be associated with a selection of one or more power save parameters 2225, including an ITO, an SPP, a DTIM periodicity, or a sleep mode (such as an SPP sleep mode). The block diagram 2200 may include a traffic classifier that classifies a traffic flow into a traffic class and an RL algorithm (such as an RL framework) that jointly configures (such as jointly optimizes) latency and power in accordance with a result of (such as an output of) the traffic classifier. An output of the RL algorithm may include information indicative of an ITO, an SPP, a DTIM periodicity, or a sleep mode (such as an SPP sleep mode).

The block diagram 2200 may include at least a first stage associated with identifying a latency constraint of a most delay intolerant application (such as a most delay intolerant traffic flow) and a second stage associated with identifying one or more power save parameters 2225 (such as an ITO-SPP value pair, a DTIM periodicity, and a sleep mode while meeting the latency constraint). A host framework 2205 may include a traffic classifier and a Wi-Fi latency manager (WLM). The traffic classifier may classify a traffic flow or an application as a traffic class 2210. Traffic classes 2210 may include video call, audio call, video stream, game, or unknown. If the traffic class 2210 is unknown, the wireless communication device may skip the RL framework and perform a different type of PM operation for the traffic flow. The WLM may provide an output of ULL or normal (such as normal latency).

In some implementations, the traffic classifier framework may take a specific amount of time for sample data collection and feature extraction to learn a new traffic type. In some aspects, the traffic classifier may learn a new traffic type (once) for every new incoming flow (such as on a per-flow basis). After learning a new traffic type, the traffic classifier may spend a specific amount of time per sample for detection or prediction.

The output of the WLM and the output of the traffic classifier may be mapped to a traffic type bucket 2215. Traffic type buckets 2215 may include a video call bucket, a ULL bucket, an audio call bucket, a gaming bucket, and a stream bucket. Thus, incoming traffic is classified on a per flow basis, with a traffic classifier output being mapped to a corresponding traffic type bucket. A traffic type bucket 2215 may include or be associated with information indicative of a latency constraint, a DTIM period, and an ITO-SPP set (such as a set of candidate values for each of ITO and SPP). In some aspects, the WLM ULL configuration may overwrite the traffic classifier classification. For example, a ULL traffic type bucket may be selected if the WLM outputs an indication of a ULL configuration.

Some example power save parameters associated various types of traffic classifier classifications are illustrated in the table below. In some examples, Web browsing and Gaming benefit from ML-based power save parameter selection due to dynamic nature of traffic for these traffic flow classifications. For example, each game has different traffic pattern and web-browsing depends upon what the upcoming feed is like (video content vs. text/images).

| Traffic | Traffic | | DTIM | |
|---|---|---|---|---|
| Classifier | Type | Latency | Periodicity | |
| Classification | Buckets | Constraint | (ms) | ITO-SPP Set |
| Video | Stream | 40 | >=300 | ITO: 25, 35, 50, 60 |
| Streaming/ | | | | SPP: 30, 55, 70, 85 |
| Web-browsing | | | | |
| Voice Call | Audio | 20 | 100 | ITO: 25, 35, 50, 60 |
| | Call | | | SPP: 30, 55, 70, 85 |
| Video Call | Video | 20 | 100 | ITO: 25, 35, 50, 60 |
| | Call | | | SPP: 30, 55, 70, 85 |
| Gaming | Game | 10 | 100 | ITO: 15, 30, 40, 55 |
| (WLM - | | | | SPP: 25, 40, 50, 65 |
| Normal) | | | | |
| Gaming | ULL | <=1 | 100 | ITO: 145, 165, |
| (WLM - ULL) | | | | 185, 200 |
| | | | | SPP: 15, 25, 40, |
| | | | | 50, 65 |

A wireless communication device may use the characteristics associated with a traffic type bucket to select one or more power save parameters 2225. For example, the wireless communication device may select a DTIM periodicity in accordance with the traffic type bucket corresponding to the traffic flow (such as the most latency sensitive traffic flow). In some implementations, the wireless communication device may provide the ITO-SPP set and the latency constraint to the RL framework 2220 for selection of one or more of an ITO value, an SPP value, and a sleep mode. The RL framework 2220 may include one or multiple RL models. For example, the RL framework 2220 may include a power penalty estimator, a latency estimator, and a congestion estimator that provide information to a model associated with a joint configuration (such as a joint evaluation or a joint optimization) of power and latency.

The power penalty estimator may track, compute, select, identify, predict, determine, extract, or otherwise obtain information associated with power consumption of different procedures or operations of the wireless communication device. Such procedures may include a sleep-to-wake (S2W) transition, a wake-to-sleep (W2S) transition, or transmissions of frames indicating PM=0 or PM=1. The power penalty estimator also may track a floor current associated with one or more different sleep modes. Thus, the power penalty estimator may provide a power penalty for a selected ITO-SPP combination (such as a selected ITO-SPP value pair). The power penalty estimator may be associated with estimates or calculations of a power consumption across listen, sleep, and PM0/1 NDP phases. Further, the power penalty estimator may track chip-specific configurations associated with a transition time and duration, a floor current, and the like.

The power penalty estimator may collect one or more statistics. Such statistics may be collected after the wireless communication device exits power save (PM=0 acknowledged). Such statistics may include a sleep time, a transition time (S2W or a W2S), a transmission time, a reception time, a total time, and a listen time. A sleep time may be a period between a last PM=1 NDP and a current PM=0 NDP and may include both long sleep and SPP durations. A transmission time may include a duration of all transmission packets, a packet length and rate dependent factor, and may be used to determine, select, ascertain, estimate, or predict an accurate listen time. A reception time may include a total duration of all reception packets, a pack length and rate dependent factor, and may be used to determine, select, ascertain, estimate, or predict an accurate listen time. A total time may include a duration between a (start of a) previous time epoch and a (start of a) current time epoch. A listen time may be calculated in accordance with Listen time=Total time-Sleep time-Rx time-Tx time, and may be further categorized into different types of listen operations, such as a normal power listen (NPL) and a light power listen (LPL). A wireless communication device may use a counter for tracking an LPL duration.

The power penalty estimator may calculate an epoch energy (P) in accordance with: Epoch Energy (P)=(Listen time*Listen current)+ (Sleep time*Sleep current)+(Transition time*Transition current). Further, the power penalty estimator may use an epoch energy normalization factor (P0), which may be a power taken to send NDP PM=0/1 frames. The epoch energy normalization factor may depend on one or more of the following factors including a sleep mode selected (such as light sleep or deep sleep), an S2W or W2S duration and power, a minimum ITO duration and listen power, a maximum SPP duration and sleep power, and an NDP PM=0/1 transmission duration.

A wireless communication device may perform a power penalty estimate using P and P0 at decision epochs, which may be understood as a start of a time epoch. In some aspects, statistics may be collected and averaged at every PS exit. Decision epochs at which a new ITO-SPP selection is performed may include several such PS exits with statistics collected (and averaged) over a duration of the last decision epoch to the current decision epoch.

The power penalty estimator may use (such as maintain) one or more static chip-specific configurations including one or more transition times, one or more transition currents, one or more sleep currents, one or more power penalty normalization factors, one or more listen currents, and a light sleep entry threshold. The one or more transition times may be measured in microseconds or ms and may include an S2W duration for deep sleep, an S2W duration for light sleep, an W2S duration for deep sleep, and a W2S duration for light sleep. The one or more transition currents may be measured in milli Ampere at Battery (mAB) and may include an S2W current for deep sleep, a W2S current for deep sleep, an S2W current for light sleep, and a W2S current for light sleep. The one or more sleep currents may be measured in mAB and may include a floor current for deep sleep and a floor current for light sleep. The one or more power penalty normalization factors may include a normalization factor for deep sleep and a normalization factor for light sleep. The one or more listen currents may be measured in mAB and may include an NPL current and an LPL current. The light sleep entry threshold, which may be measured in microseconds or ms, may be an SPP duration below which light sleep is to be entered. In some aspects, deep sleep may be associated with a DTIM sleep entry. Further, power penalty normalization factors (P0) may be computed at run-time in some deployment scenarios.

The latency estimator may estimate an average latency of an incoming traffic pattern and may provide a latency penalty for a selected ITO-SPP combination (such as for a selected ITO-SPP value pair). In some aspects, the latency estimator may compute a latency estimate per ITO-SPP value pair and may compute a latency penalty using the estimate and the constraint (such as the latency constraint provided by a traffic type bucket). The latency estimator may maintain one or more (static) configurations. Such configurations may include a congestion metric (which may be equivalently referred to herein as a congestion factor or a congestion value) based random backoff (RBO) minimum threshold table (congestion metric-based RBO_MIN_THRESHOLD table), a congestion factor based RBO maximum threshold table (congestion metric-based RBO_MAX_THRESHOLD table), and a congestion factor based latency adder table. Such thresholds, by way of being “congestion metric based,” may be understood as being alterable, configurable, or tunable in accordance with congestion.

The latency estimator may initialize RBO_MIN_THRESHOLD and RBO_MAX_THRESHOLD in accordance with a congestion metric and may start tracking “buffered” and “new” packets after the wireless communication device exits PS (such as after PM=0 sent and acknowledged). The latency estimator may track arrival timestamps and calculate inter-packet interval for reception packets. An inter-packet interval may be such that inter-packet interval=(current received packet timestamp-previous received packet timestamp). If the first packet after PM=0 is sent is transmitted, an inter-packet interval may be a duration between a last transmitted packet and a first received packet. If the first packet after PM=0 is sent is received, an inter-packet interval may be a duration between PM=0 (wireless communication device exiting PS) and a current received packet arrival time.

If a first packet's inter-packet interval is less than the RBO_MIN_THRESHOLD, the wireless communication device (via the latency estimator) may stop tracking received inter-packet intervals (and all packets from there on, including the current packet, may be accounted for as “new packets”). If a first packet's inter-packet interval is greater than RBO_MIN_THRESHOLD, the wireless communication device (via the latency estimator) may continue tracking the received inter-packet interval. Further, if an inter-packet interval is greater than RBO_MAX_THRESHOLD, the wireless communication device may account for all received packets before the current packet as “buffered packets” (and may account for the current packet and all received packets thereafter as “new packets”) and may stop tracking packet arrival timestamps (and continue counting incoming received packets).

The latency estimator may stop tracking new-buffered packets in accordance with the wireless communication device entering PS (such as in accordance with a PM=1 transmission). The latency estimator may calculate a sleep time and a “buffered” packet latency, with sleep time=MIN(duration between previous PM=1 and current PM=0, duration between DTIM with TIM set and PM=0) and with buffered packet latency=sleep time divided by 2 (such as sleep time/2). The latency estimator may calculate “new” packets latency, calculate a latency estimate, and store the latency estimate per ITO-SPP (such as per ITO-SPP value pair). Some example latency estimator configuration tables are illustrated below.

Congestion based Latency Adder Lookup Table (2G)

| Congestion | New Packet |
|---|---|
| Metric | Latency Adder |
| 0 | Value1 |
| 20 | Value2 |
| 40 | Value3 |
| 60 | Value4 |
| 80 | Value5 |
| 100 | Value6 |

Congestion based Latency Adder Lookup Table (5G)

| Congestion | New Packet |
|---|---|
| Metric | Latency Adder |
| 0 | Value1 |
| 20 | Value2 |
| 40 | Value3 |
| 60 | Value4 |
| 80 | Value5 |
| 100 | Value6 |

Congestion based RBO_MIN_THRESHOLD Lookup Table

| Congestion | RBO_MIN_THRESHOLD |
|---|---|
| Metric | Adder |
| 0 | Value1 |
| 20 | Value2 |
| 40 | Value3 |
| 60 | Value4 |
| 80 | Value5 |
| 100 | Value6 |

Congestion based RBO_MAX_THRESHOLD Lookup Table

| Congestion | RBO_MAX_THRESHOLD |
|---|---|
| Metric | Adder |
| 0 | Value1 |
| 20 | Value2 |
| 40 | Value3 |
| 60 | Value4 |
| 80 | Value5 |
| 100 | Value6 |

Traffic Type dependent
RBO_MIN/MAX_THRESHOLD
Lookup Table

| | Access | Nominal |
|---|---|---|
| | Category | RBO_MIN_THRESHOLD |
| Protocol | (AC) | (usec) |
| 11ac | Audio | Value1 |
| | Video | Value2 |
| | BE | Value3 |
| 11ax | Audio | Value4 |
| | Video | Value5 |
| | BE | Value6 |
| 11be | Audio | Value7 |
| | Video | Value8 |
| | BE | Value9 |

In some examples, a latency estimation scheme or procedure may be associated with calculating a time until a first packet is received (active period, post PM=0) and performing one or more actions in accordance with the calculated time. For example, if this time is less than RBO_MIN_THRESHOLD, mark as “Buffered packet.” An interval between subsequent received packets may be calculated. If the interval is less than threshold (RBO_MAX_THRESH), the packets may be marked as “buffered packets.” Otherwise, the wireless communication device may mark the packets as “new packets.” The wireless communication device may calculate a buffered packets latency=(Duration from start of sleep to 1st Rx)/2 (such as to account for beacon monitoring wakeups). The wireless communication device may calculate a new packets latency=fn(congestion) (such as via a congestion metric based look up table). The wireless communication device may calculate a latency estimate=((number of buffered packets*buffered packets latency)+(number of new packets*new packets latency))/(total number of packets). A latency estimate may assume or expect that downlink arrivals are spread out uniformly across a sleep duration.

Further, in some aspects, the wireless communication device (via the latency estimator) may track the received packets for a most latency-sensitive flow if the wireless communication device has multiple active traffic flows. By addressing the most latency-sensitive traffic flow, the wireless communication device may automatically satisfy the latency expectations/constraints associated with the other traffic flows. In some aspects, the wireless communication device may support and employ sufficiently separated latency constraints to avoid failing to satisfy a latency expectation in examples in which an AP does an explicit prioritization for a traffic flow and if the latency target of another traffic flow is relatively close or similar. For example, if latency targets for two traffic flows are 5 ms and 10 ms, respectively, and if the AP performs explicit prioritization for the 5 ms traffic flow, the client device may see the 5 ms target being met but the 10 ms target being violated. Thus, the client device and the AP may coordinate (such as via exchanged signaling) information associated with different traffic flows or different traffic classes to increase the likelihood of sufficiently separated latency constraints between different traffic flows.

As described herein, the latency estimator may interface with the congestion estimator, such that a congestion metric joint estimator may be understood as being available in association with the latency estimator. The congestion estimator may provide a congestion estimate (a congestion metric value) and a latency adder associated with (such as calculated or estimated in accordance with) the congestion estimate. The congestion-related aspects for the latency estimator may be associated with an accounting and an estimation. Regarding estimation, the congestion estimator may operate by observing an amount of medium congestion and volume of directed traffic to estimate overall congestion. The congestion estimator may obtain a congestion metric value in accordance with a function of the medium congestion and the volume of directed traffic. In some aspects, the wireless communication device may calculate a congestion metric based look up table per band to account for unique channel characteristics of each band.

Regarding accounting, in some aspects, new packets may incur latency adder due to congestion while buffered packets may not incur the latency adder due to congestion (with received packets delivered within RBO_MIN/MAX_THRESHOLD marked as “Buffered” and with RBO_MIN_THRESH/RBO_MAX_THRESHOLD obtained, extracted, or selected from (Traffic Type/congestion metric) look up tables). A congestion metric-based look up table format may be associated with an input of a congestion metric joint estimate and an output of a per packet latency and RBO_MAX/MIN_THRESHOLD adders. In some aspects, the wireless communication device may feed (such as input) the look up table output to the latency estimator, such that the per packet latency and RBO_MAX/MIN_THRESHOLD adders are added to each new packet's latency and such that RBO_MIN/MAX_THRESHOLDs for new/buffered packet tracking are updated. In some aspects, the congestion metric based look up tables may be statically configured, such as configured in accordance with offline congestion latency analysis. Additionally, or alternatively, the congestion metric based look up tables may be dynamically configured or signaled. In some aspects, the congestion metric based look up tables may not be chip-specific.

In some aspects, the wireless communication device may tune, update, adjust, refine, or change RBO_MIN_THRESHOLD and RBO_MAX_THRESHOLD as a function of congestion (congestion metric) and traffic classification. For example, with respect to being a function of congestion, RBO_MIN(MAX)_THRESHOLD=Nominal RBO_MIN(MAX)_THRESHOLD+latency adder as a function of congestion. Such latency adder values may be selected from a latency adder look up table that also may be used for “new” packets.

For further example, with respect to being a function of traffic classification, the wireless communication device may set nominal RBO_MIN_THRESHOLD and RBO_MAX_THRESHOLD in accordance with a traffic identifier (TID). For example, RBO_MIN_THRESHOLD=Max RBO of the corresponding TID. Additionally, or alternatively, RBO_MAX_THRESHOLD=RBO_MIN_THRESHOLD+Delta. Delta may be set to some default value, such as a zero value, and adjusted up. Some example congestion and traffic type based/dependent thresholds are illustrated by the tables shown below. A latency added may be counted for new packets (such as all new packets) (unbuffered) arriving after RBO_MAX_THRESHOLD delay. The wireless communication device may exclusively use a table or may use a trendline associated with a table.

Congestion based
RBO_MIN/MAX_THRESHOLD
Adder Lookup Table

| Congestion | RBO_MIN/MAX_THRESHOLD |
|---|---|
| Metric | Adder (ms) |
| 0 | Value1 |
| 20 | Value2 |
| 40 | Value3 |
| 60 | Value4 |
| 80 | Value5 |
| 100 | Value6 |

Traffic Type dependent
RBO_MIN/MAX_THRESHOLD
Lookup Table

| | Access | |
|---|---|---|
| | Category | Nominal |
| Protocol | (AC) | RBO_MIN_THRESHOLD |
| 11ac | Audio | Value1 |
| | Video | Value2 |
| | Voice | Value3 |
| | BK | Value4 |
| 11ax | Audio | Value5 |
| | Video | Value6 |
| | Voice | Value7 |
| | BK | Value8 |
| 11be | Audio | Value9 |
| | Video | Value10 |
| | Voice | Value11 |
| | BK | Value12 |

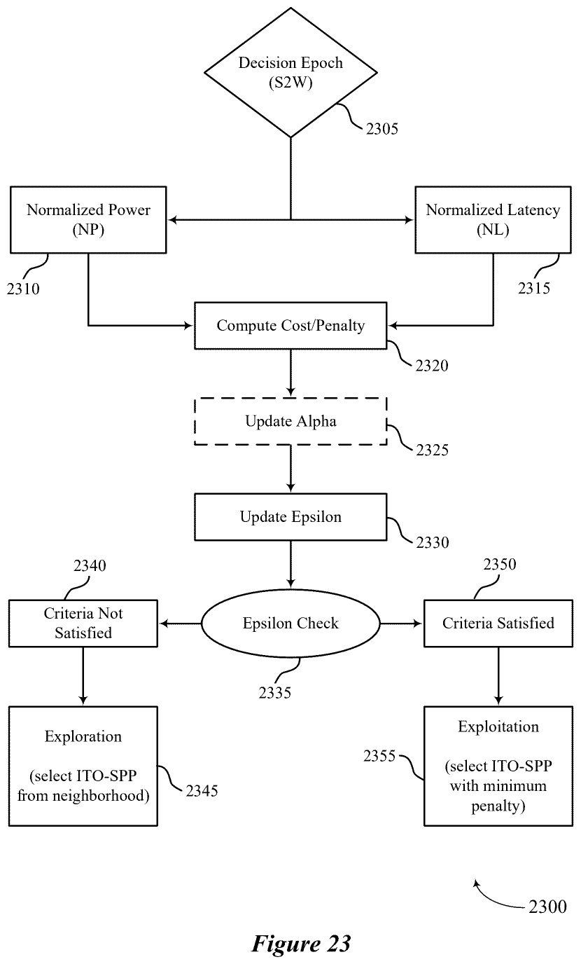

FIG. 23 shows an example flowchart 2300 that supports power save parameter selection at a client device in accordance with a joint evaluation of latency and power consumption. The flowchart 2300 illustrates an example sequence of estimations, calculations, determinations, selections, or predictions associated with an RL framework according to which the RL framework may output an indication of at least a selected ITO-SPP value pair, such as in accordance with inputs of an ITO-SPP set and a latency constraint associated with a traffic flow (such as a latency constraint indicated by a traffic type bucket to which a traffic flow, or a traffic class associated with the traffic flow, is mapped). In other words, the flowchart 2300 may illustrate a sequence of estimators, algorithms, models, or other software, firmware, or hardware components or functionalities associated with collectively outputting an indication of one or more power save parameters, such as an ITO value, an SPP value, and a sleep mode.

A wireless communication device may trigger or initiate the flowchart 2300 (and, likewise, the RL framework) at a decision epoch 2305. A decision epoch 2305 may correspond to a start of a given time period, such as a start of a given time epoch. In some aspects, a decision epoch 2305 may correspond to a transmission time of an uplink frame sent by the wireless communication device including a PM bit (such as a PM=0 bit). For example, the decision epoch 2305 may correspond to a signaled indication from the wireless communication device that the wireless communication device is in an awake state, which may be associated with an S2W transition. In some implementations, a decision epoch 2305 may be every N^{th} S2W instance, where N may be a configurable value. A quantity of steps may be equal to or otherwise associated with a quantity of decision epochs for which an ITP-SPP selection is performed.

In accordance with triggering or initiating the flowchart 2300, the wireless communication device may compute, select, determine, ascertain, predict, or otherwise obtain a power consumption metric and a latency metric. For example, the wireless communication device may select the power consumption metric and the latency metric in parallel with outputting the indication that the wireless communication device is in an awake state. In some aspects, the power consumption metric may be a normalized power consumption metric and may be referred to as a normalized power (NP) 2310. In some aspects, the latency metric may be a normalized latency metric and may be referred to as a normalized latency (NL) 2315. The wireless communication device may compute the NP 2310 as P/P0 (a power consumption P divided by a power normalization factor P0). In some aspects, P0 (which may be equivalently denoted as P₀) may be computed such that:

$${P}_{0} = \frac{[ w2s\_duration * w2s\_current + s2w\_duration * s2w\_current + listen\_current * min\_ITO + tx\_current * tx\_duration + sleep\_current * max\_SPP ]}{w2s\_duration + s2w\_duration + min\_ITO + tx\_duration + max\_SPP}$$

The wireless communication device may compute the NL 2315 as a [MIN(threshold_value, Lₑₛₜ/L_{Constraint})], with Lₑₛₜ being an estimated average latency added due to one or more power save parameters (such as, in other words, an estimate of the latency of downlink packets for a given action, such as a previous action selected during a previous decision epoch) and L_{Constraint} being a target latency adder due to one or more power save parameters. In some aspects, Lₑₛₜ may be obtained as an output of a latency estimator and L_{Constraint} may be obtained as a characteristic associated with a traffic type bucket. In some aspects, the wireless communication device may compute the NL 2315 such that NL 2315 is at least a threshold_value. The threshold_value may alternatively be referred to herein as a latency_penalty_lower_bound. In other words, the wireless communication device may set a minimum or lower limit value for the NL 2315 and, in some examples, such a minimum value may be set to 0.5 (although other minimum values are within the scope of the present disclosure). Thus, an RL algorithm may adjust NL 2315 over time but may be unable to decrease NL 2315 below the minimum value set by the wireless communication device.

In accordance with obtaining the NP 2310 and the NL 2315, the wireless communication device may compute, obtain, determine, select, identify, or otherwise ascertain a penalty value 2320 (such as a cost value) associated with NP 2310 and NL 2315. Because NP 2310 and NL 2315 may correspond to (such as be caused by) a previous selection of one or more power save parameters (such as ITO, SPP, DTIM periodicity, or sleep mode), the penalty value 2320 may be understood as being computed for each, for example, (ITO, SPP+DTIM) pair (at least over time, such as across two or more decision epochs). The wireless communication device may compute the penalty value P such that P (latency estimate=Lest, energy=P)=α min(threshold_value, Lₑₛₜ/L_{constraint})+(1−α)P/P0. In other words, P=αNL+(1−αNP). Thus, α 2325 may be understood as a latency vs. tradeoff factor.

In some implementations, α 2325 may be adapted online (such as on-the-fly or dynamically). For example, in some aspects, alpha 2325 may be understood as an adaptive alpha. For example, the wireless communication device may update alpha 2325 such that α=α+γₖ (Lₑₛₜ−L_{constraint}). Alpha 2325 may be limited between [0:1]. In some aspects, γₖ=MAX(γ0 β^{k}, γ_{Min}), with β being a decay factor. The wireless communication device may selectively update alpha 2325. For example, the wireless communication device may refrain from updating alpha 2325 at some decision epochs and may update alpha at some other decision epochs. For example, the wireless communication device may update alpha 2325 every 5 decision epochs or every 10 decision epochs, among other examples. The alpha update interval may be set such that alpha 2325 is updated at fixed intervals. Generally, the wireless communication device may update alpha 2325 every M^{th} step, where M may be configurable. Thus, every M^{th} step may be understood or treated as an alpha update interval.

The wireless communication device may perform an initial exploration of various ITO-SPP value pairs to compute multiple different penalty values, such as a respective penalty value for each unique ITO-SPP value pair. The initial exploration phase may be referred to as a “learning phase/period” and may be triggered (once) per traffic type bucket. If any given traffic type bucket has undergone a learning phase previously, the wireless communication device may bootstrap (save-restore) previously learned statistics. As part of the initial exploration phase, the wireless communication device may initiate, for example, a round robin selection of every ITO-SPP combination (such as every ITO-SPP value pair), which may increase the likelihood of all potential ITO-SPP combinations being covered in the learning phase. The wireless communication device may update the cost/penalties for each ITO-SPP combination in accordance with the round robin selection.

Each traffic type bucket may store the latest collected statistics for bootstrapping. For example, during a save-restore procedure, during traffic type bucket switch, the wireless communication device may save statistics collected for current bucket and restore stats of the new bucket. Further, RL parameters such as alpha 2325, epsilon, step count, and alpha step count along with cost/penalty and latency estimate matrix (per ITO-SPP) may be accounted for. Learning phase statistics are save-restored to avoid delays in picking power save parameters. As part of such an initial learning/exploration phase for the RL framework, the phase may take an amount of time proportional to a size of an ITO-SPP combination matrix. Traffic type bucket switch within learning phase also may undergo save-restore, and bootstrapped from last picked values thereby ensuring no (or otherwise reducing the likelihood of) repeat of learning cycles.

After initial exploration, at each decision epoch and with probability (1-€), the wireless communication device may select an action (such as an ITO-SPP value pair) with a minimum (such as relatively smallest) penalty value of the multiple penalty values known to the wireless communication device (such as already or previously computed). With a probability of e, the wireless communication device may select a random action (such as a random ITO-SPP value pair). In some implementations, the wireless communication device may select a random action in an immediate neighborhood (such as in the proximity of) an action associated with the relatively smallest penalty value (which may be understood as an “optimal” or “best” action known to the wireless communication device). In other words, the wireless communication device (via the RL algorithm/framework illustrated by the flowchart 2300) may select an (ITO, SPP) value pair that has a relatively smallest average penalty most of the time (such as with probability (1-€)) and may explore some nearby (ITO, SPP) value pair with a relatively smaller probability E.

For example, the wireless communication device may perform an epsilon check 2335 and select an action (an ITO-SPP value pair) in accordance with whether a criteria associated with the epsilon check is satisfied. If the criteria is satisfied, at 2350, the wireless communication device may perform an exploitation 2355 and select an ITO-SPP value pair with a relatively smallest penalty. If the criteria is not satisfied, at 2340, the wireless communication device may perform an exploration 2345 and select an ITO-SPP value pair within a general neighborhood of an ITO-SPP value pair with the relatively smallest penalty. In some aspects, the criteria may be two-fold and may be associated with a threshold quantity of explore steps (min_explore_steps) and a threshold value of A_MAX(epsilon, epsilon_min). If a total quantity of actions (total_num_actions) performed by the wireless communication device exceeds the threshold quantity of explore steps and if a random epsilon (rand_eps) is greater than the threshold value of A_MAX(epsilon, epsilon_min), the criteria may be satisfied. Otherwise, if the total quantity of actions performed by the wireless communication device is less than the threshold quantity of explore steps or if the random epsilon (rand_eps) is less than the threshold value of A_MAX(epsilon, epsilon_min), the criteria may not be satisfied.

After the initial learning/exploration phase, when switching traffic type bucket, the last selected ITO-SPP are taken as the start point (bootstrapped with save-restore). Further, an expectation may be that post learning phase, suitable power save parameters (parameters associated with smallest penalty value or parameters that are in the proximity (neighborhood) of the smallest penalty value) are selected and this phase kicks off using such suitable parameters.

In some aspects, e may decay with a quantity of decision epochs up to a minimum value. For example, at each decision epoch 2305, the wireless communication device may update epsilon at 2330. The wireless communication device may update epsilon in accordance with €=(epsilon_taper_duration*epsilon_min)/((epsilon_taper_duration*epsilon_min)+((1−epsilon_min)*(total_num_actions-min_explore_steps))). In other words, after an initial exploration phase, the wireless communication device may decay epsilon based on current step(s) and beta. The wireless communication device may initiate an epsilon update 2330 at every decision epoch 2305. The wireless communication device may trigger a neighborhood search with probability equal to epsilon. A range of the neighborhood search (from the relatively lowest penalty ITO-SPP combination) may be referred to as an exploration window, and may be +/−1 from one or both of ITO and SPP, +/−2 from one or both of ITO and SPP, and so on. An increment of +/−N from ITO or SPP may be understood as being able to select an ITO or SPP value at most N ITOs or SPPs away from the ITO or SPP associated with the relatively smallest penalty value, with ITO and SPP values ordered in an increasing or decreasing order and including the candidate values provided by the traffic type bucket. The wireless communication device may trigger exploitation with probability of (1-€) and may trigger either exploration or exploitation (such as one or the other, and not both) at every decision epoch in accordance with the probability E.

An example table illustrating the available or possible ITO-SPP pairs is shown below. In accordance with the example illustrated below, the wireless communication device may have calculated a first penalty value for (ITO=35 ms, SPP=20 ms), a second penalty value for (ITO=30 ms, SPP=45 ms), and a third penalty value for (ITO=45 ms, SPP=40 ms).

| Possible ITO values (ms) | | | | | |
|---|---|---|---|---|---|
| 25 | 30 | 35 | 40 | 45 | 50 |

| | | | | |
|---|---|---|---|---|
| Possible SPP | 15 | | | |
| values (ms) | 20 | | P(35, 20) | |
| | 25 | | | |
| | 35 | | | |
| | 40 | | | P(45, 40) |
| | 45 | P(30, 45) | | |
| | 55 | | | |

Further, in some implementations, the wireless communication device may use the RL framework to select a DTIM periodicity and a sleep mode. The wireless communication device may select a larger DTIM periodicity for latency tolerant traffic and may select a shorter DTIM periodicity for latency sensitive traffic. Latency tolerant traffic may include traffic flows associated with, for example, YouTube or web browsing (such as non-gaming, non-interactive traffic). Example DTIM periodicities for various traffic flows (such as application types or traffic classes) are illustrated in the table below.

| | Potential | |
|---|---|---|
| | DTIM | |
| Use Case | Period | Comments |
| Video Streaming/ | >=300 | Higher DTIM period helps use cases |
| Web-browsing | | such as YouTube which have bursty |
| | | DL traffic after long intervals |
| | | (several seconds) |
| Gaming | 100 | Lower DTIM sleep for reducing latency |
| | | adder due to long STA sleep cycles |
| Audio/Video | 100 | Larger periodicity compared to gaming |
| Call | | but less than Video Streaming buckets |
| ULL | 100 | Like Gaming, minimum DTIM period |
| | | to ensure least STA sleep dependent |
| | | latency adder |
| Unknown | NA | Use other power management scheme |
| | | for unknown traffic buckets |

To select a sleep mode, the wireless communication device may select between light sleep (LS) and deep sleep (DS) in accordance with a minimization (such as reduction) of energy under a curve, the curve associated with a time to sleep and a transition cost. In some aspects, the wireless communication device may set the SPP threshold to enter light sleep such that (SPP Duration*LS Floor Current)+ (LS Transition Time*LS Transition Current)=(SPP Duration*DS Floor Current)+ (DS Transition Time*DS Transition Current). In other words, the threshold “SPP Duration” may be set such that SPP Duration=[(DS Transition Time*DS Transition Current)−(LS Transition Time*LS Transition Current)/(LS Floor Current-DS Floor Current)]. If the SPP value selected is greater than the SPP Duration threshold, the wireless communication device may select to enter a deep sleep. Otherwise, the wireless communication device may enter a light sleep.

In some implementations, the wireless communication device may support SPP suppression in deep sleep mode for latency tolerant traffic. For example, video streaming traffic such as YouTube are often bursty with long idle periods (of the order of hundreds of ms or even seconds) between bursts. For such traffic, the wireless communication device may introduce or employ an additional set of actions in the RL algorithm, namely, (SPP>DTIM), which may be for a given ITO value. When this action is invoked, (such that selected SPP value is greater than DTIM), either during exploration or exploitation phase, the wireless communication device may skip SPP and directly enter DTIM sleep after an ITO. In some examples, to keep the latency penalty manageable for this action, the wireless communication device may set next wake up equal to a next target beacon transmission time (TBTT) for the first sleep cycle after ITO. The wireless communication device may use the higher (such as longer) DTIM periodicity suggested by the algorithm for subsequent sleep cycles (only) if no data activity after the first sleep cycle. In other words, the wireless communication device may partially wake up to receive a beacon frame at the next TBTT (as the wireless communication device may receive and parse a beacon frame with a limited quantity of components, modules, or functionalities in an awake or active state) and, if the beacon frame does not indicate a presence of data for the wireless communication device, the wireless communication device may re-enter a sleep state for the DTIM interval/period.

In some aspects, the wireless communication device may leverage the RL framework in addition to the traffic classifier and static look up tables to support on-the-fly learning and re-configuration that more suitably addresses flow-specific characteristics, as one single configuration or one set of power save parameters may not suitably fit all traffic flows, even traffic flows within a same traffic class. For example, different applications within a same traffic class may have different traffic arrival patterns. Thus, a set of power save parameters (ITO, SPP, and DTIM periodicity) that is suitable for one traffic arrival profile may not be suitable for another. Further, even within a same application flow, a traffic arrival pattern may change over time depending on user activity. Thus, a run-time selection of power save parameters (ITO, SPP, and DTIM periodicity) may allow for greater flexibility in latency/power tradeoffs even for a same average latency constraint.

Further, differences in AP scheduling/aggregation behavior across vendors as well as backhaul network quality may cause variations in a traffic pattern for a same application. Some example implementations involving the RL framework may enable dynamic adjustment of power save parameters over time, which may result in a more suitable power/latency tradeoff as compared to an attempt to configure a single static setting that will work across all potential profiles. Further, a congestion profile may vary widely depending on OBSS traffic patterns, even for a same average congestion metric value. In such examples, a same (congestion metric, traffic classifier) look up table may not work suitably across all such potential congestion profiles. Further, a power penalty and a resulting choice of (ITO, SPP) may depend on platform-specific parameters such as S2W and W2S transition currents and durations, transmission/listen currents, DTIM periodicity, and the like. Thus, any static look up table may be associated with an expectation for significant platform-specific retuning, which may result in a potentially wide variation in at least a power penalty depending on platform parameters.

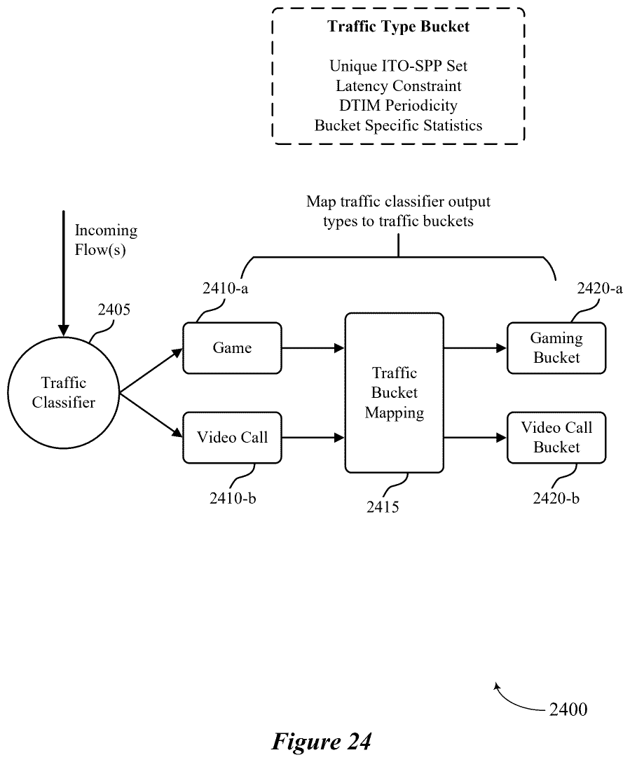

FIG. 24 shows an example classification 2400 that supports power save parameter selection at a client device in accordance with a joint evaluation of latency and power consumption. The classification 2400 may be associated with a classification, mapping, or sorting of a traffic flow 2410 (such as a traffic type or a traffic class) to a traffic type bucket 2420 for the RL framework (such as for the RL framework to use characteristics associated with the traffic type bucket to select one or more power save parameters). The traffic classifier 2405 traffic types/classes may map to traffic type buckets 2420 via traffic bucket mapping 2415. In some aspects, multiple traffic classifier traffic types/classes may be mapped to a same traffic type bucket 2420. Some example traffic type buckets 2420 include a gaming bucket 2420-a (such as corresponding to a gaming traffic flow 2410-a), a video call bucket 2420-b (such as corresponding to a video call traffic flow 2410-b), an audio call bucket, a streaming bucket, an a ULL bucket (which may be used in accordance with WLM Indication). A traffic type bucket 2420 may contain parameters including one or more of a supported ITO-SPP set, a latency constraint, a DTIM periodicity, and statistics collected (used when switching between buckets).

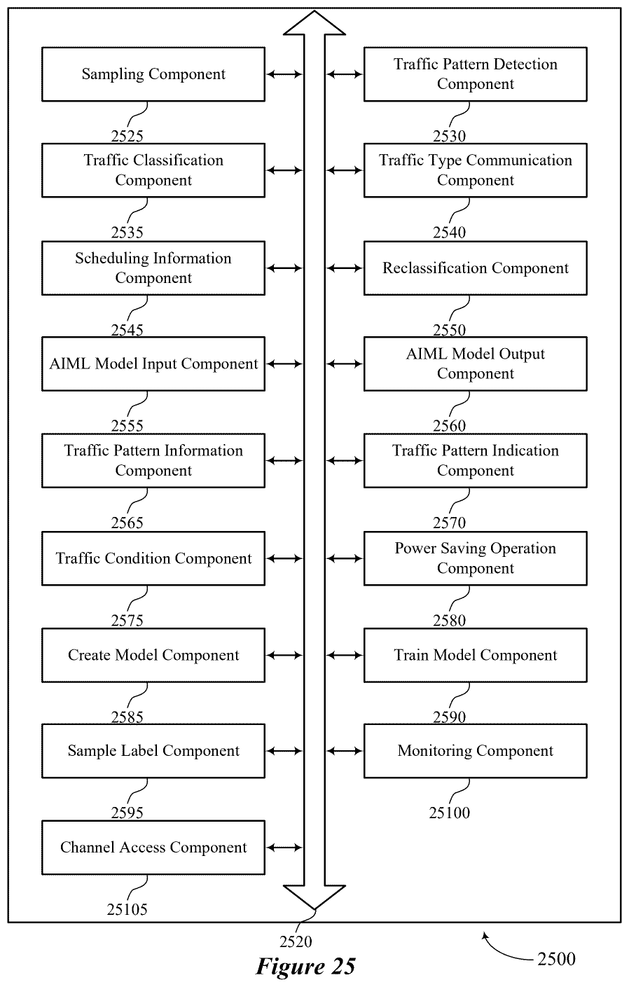

FIG. 25 shows a block diagram 2500 of a first wireless communication device 2520 that supports a traffic classifier for service aware Wi-Fi operation. The first wireless communication device 2520 may be an example of aspects of an AP 102 as described with reference to FIGS. 1 through 24. The first wireless communication device 2520, or various components thereof, may be an example of means for performing various aspects of traffic classifier for service aware Wi-Fi operation as described herein. For example, the first wireless communication device 2520 may include a sampling component 2525, a traffic pattern detection component 2530, a traffic classification component 2535, a traffic type communication component 2540, a scheduling information component 2545, a reclassification component 2550, an AIML model input component 2555, an AIML model output component 2560, a traffic pattern information component 2565, a traffic pattern indication component 2570, a traffic condition component 2575, a power saving operation component 2580, a create model component 2585, a train model component 2590, a sample label component 2595, a monitoring component 25100, a channel access component 25105, or any combination thereof. Each of these components, or components or subcomponents thereof (such as one or more processors, one or more memories), may communicate, directly or indirectly, with one another (such as via one or more buses).

Further, various components of the first wireless communication device 2520 may provide means for performing the methods described herein. In some examples, means for transmitting and/or receiving may include the transceivers and/or antenna(s) of the first wireless communication device 2520. In some examples, means for outputting or sending (such as means for outputting for transmission) and means for obtaining (such as means for obtaining after information is received from a different device) may include one or more interfaces of the first wireless communication device 2520 to output signals to other components or obtain signals from other components of the first wireless communication device 2520. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for detecting, means for classifying, means for communicating, means for creating, means for training, means for labeling, means for reclassifying, means for performing, means for monitoring, means for reinstating, means for selecting, and/or means for updating, include a processing system, processor circuitry (including one or more processors), memory circuitry, and/or computer-readable media of the first wireless communication device 2520.

The first wireless communication device 2520 may support wireless communication in accordance with examples as disclosed herein. The sampling component 2525 is configurable or configured to obtain a set of multiple samples associated with a set of multiple packets including data. The traffic pattern detection component 2530 is configurable or configured to detect one or more transmission traffic patterns associated with the set of multiple packets based on one or more parameters associated with the set of multiple samples, one or more parameters associated with a previous set of multiple samples, or both. The traffic classification component 2535 is configurable or configured to classify, based on the one or more transmission traffic patterns, the set of multiple packets according to one or more traffic types. The traffic type communication component 2540 is configurable or configured to communicate in accordance with the one or more traffic types.

In some examples, to support communicating in accordance with the one or more traffic types, the scheduling information component 2545 is configurable or configured to output scheduling information associated with the set of multiple packets, where the scheduling information is output in accordance with a channel access scheme that is based on the one or more traffic types.

In some examples, the create model component 2585 is configurable or configured to create a model to detect the one or more transmission traffic patterns. In some examples, the train model component 2590 is configurable or configured to train the model based on a stream classification service request. In some examples, the sample label component 2595 is configurable or configured to detect whether one or more portions of the set of multiple samples correspond to one or more transmission traffic types. In some examples, the sample label component 2595 is configurable or configured to label either the set of multiple samples as a set of multiple training samples for training the model or a first portion of the set of multiple samples as the set of multiple training samples, where the first portion is not detected as corresponding to a respective transmission traffic type, and where labeling the first portion is based on a second portion of the set of multiple samples corresponding to a transmission traffic type associated with the first portion. In some examples, the train model component 2590 is configurable or configured to train the model using the set of multiple training samples based on either labeling the set of multiple samples as the set of multiple training samples or labeling the first portion of the set of multiple samples as the set of multiple training samples.

In some examples, the channel access component 25105 is configurable or configured to obtain one or more channel access triggers associated with one or more channel access schemes, the one or more channel access schemes comprising the channel access scheme, where at least one of obtaining the one or more channel access triggers is based on at least one of the one or more traffic types or a compliance with a policy or outputting the scheduling information is further based on the one or more channel access triggers.

In some examples, the channel access component 25105 is configurable or configured to output one or more channel access triggers associated with one or more channel access schemes, the one or more channel access schemes comprising the channel access scheme, the output being based on the one or more traffic types, where outputting the scheduling information is further based on the one or more channel access triggers.

In some examples, to support detecting the one or more transmission traffic patterns, the traffic pattern detection component 2530 is configurable or configured to detect either real-time traffic associated with a first window of the set of multiple samples or streaming traffic associated with a second window of the set of multiple samples.

In some examples, to support classifying the set of multiple packets, the reclassification component 2550 is configurable or configured to reclassify the set of multiple packets based on a transmission traffic type confidence level being less than or equal to a threshold confidence level.

In some examples, to support detecting the one or more transmission traffic patterns, the AIML model input component 2555 is configurable or configured to output, to an artificial-intelligence model or machine-learning model, the one or more parameters associated with the set of multiple samples, where the one or more parameters include one or more quality of service requirements. In some examples, to support detecting the one or more transmission traffic patterns, the AIML model output component 2560 is configurable or configured to obtain, from the artificial-intelligence model or machine-learning model, the one or more transmission traffic patterns.

In some examples, the traffic pattern information component 2565 is configurable or configured to obtain traffic pattern information associated with one or more other access points, where the detection of the one or more transmission traffic patterns is further based on the traffic pattern information. In some examples, the traffic pattern indication component 2570 is configurable or configured to communicate an indication of the one or more detected transmission traffic patterns.

In some examples, the traffic condition component 2575 is configurable or configured to obtain one or more traffic activities, one or more traffic loads, or any combination thereof based on the one or more transmission traffic patterns, where the one or more traffic types, the one or more traffic activities, and the one or more traffic loads are each associated with a respective traffic flow of a set of multiple traffic flows, where the set of multiple traffic flows are associated with the set of multiple samples, where the communication includes performing a power saving operation in accordance with the one or more traffic types, the one or more traffic activities, the one or more traffic loads, or any combination thereof.

In some examples, the traffic condition component 2575 is configurable or configured to obtain one or more second traffic types, one or more second traffic activities, one or more second traffic loads, or any combination thereof. In some examples, the power saving operation component 2580 is configurable or configured to perform a second power saving operation in accordance with the one or more second traffic types, the one or more second traffic activities, the one or more second traffic loads, or any combination thereof.

In some examples, the monitoring component 25100 is configurable or configured to monitor, according to a first periodicity, for a first set of multiple traffic flows associated with a first transmission traffic type. In some examples, the monitoring component 25100 is configurable or configured to monitor, according to a second periodicity, for a second set of multiple traffic flows associated with a second transmission traffic type. In some examples, the monitoring component 25100 is configurable or configured to monitor, according to a third periodicity, for a third set of multiple traffic flows associated with a third transmission traffic type, where the set of multiple traffic flows include the first set of multiple traffic flows, the second set of multiple traffic flows, and the third set of multiple traffic flows. In some examples, the monitoring component 25100 is configurable or configured to implement, absent of a reclassification of the set of multiple traffic flows, one or more of the first transmission traffic type, the second transmission traffic type, and the third transmission traffic type, the implementation being in accordance with one or more activities associated with the first set of multiple traffic flows, the second set of multiple traffic flows, or the third set of multiple traffic flows and in accordance with a power saving operation at the wireless node.

In some examples, to support performing the power saving operation, the power saving operation component 2580 is configurable or configured to perform the power saving operation in accordance with one or more conditions being satisfied, where the one or more conditions include at least one of: a presence of a video streaming traffic type, an absence of a latency-sensitive or real-time traffic type, or a summation of one or more second traffic loads associated with a background traffic type being below or equal to a threshold traffic load, the one or more traffic loads including at least the one or more second traffic loads.

In some examples, the monitoring component 25100 is configurable or configured to monitor for the summation of the one or more second traffic loads associated with the background traffic type periodically.

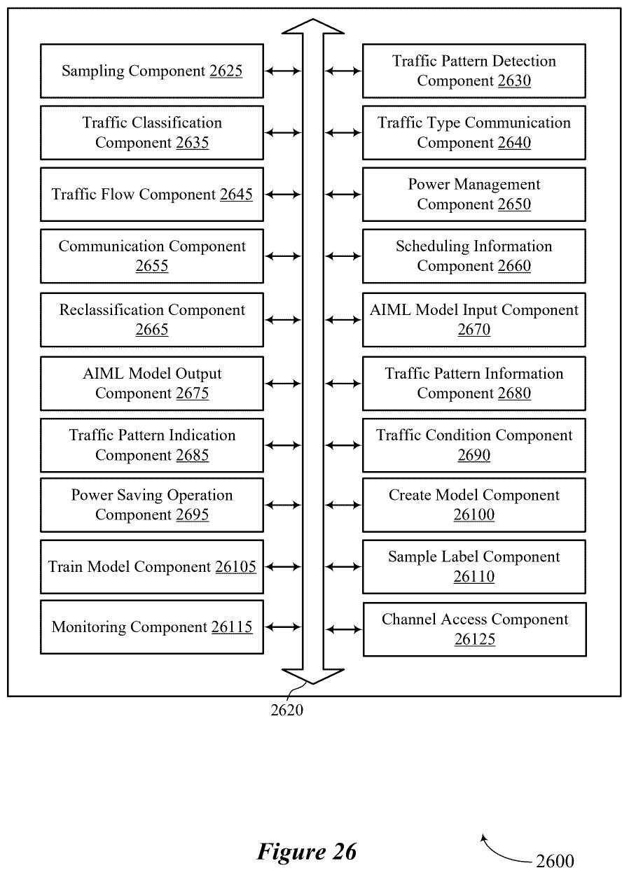

FIG. 26 shows a block diagram 2600 of a second wireless communication device 2620 that supports a traffic classifier for service aware Wi-Fi operation. The second wireless communication device 2620 may be an example of aspects of a STA 104 as described with reference to FIGS. 1 through 24. The second wireless communication device 2620, or various components thereof, may be an example of means for performing various aspects of traffic classifier for service aware Wi-Fi operation as described herein. For example, the second wireless communication device 2620 may include a sampling component 2625, a traffic pattern detection component 2630, a traffic classification component 2635, a traffic type communication component 2640, a traffic flow component 2645, a power management component 2650, a communication component 2655, a scheduling information component 2660, a reclassification component 2665, an AIML model input component 2670, an AIML model output component 2675, a traffic pattern information component 2680, a traffic pattern indication component 2685, a traffic condition component 2690, a power saving operation component 2695, a create model component 26100, a train model component 26105, a sample label component 26110, a monitoring component 26115, a channel access component 26125, or any combination thereof. Each of these components, or components or subcomponents thereof (such as one or more processors, one or more memories), may communicate, directly or indirectly, with one another (such as via one or more buses).

The second wireless communication device 2620 may support wireless communication in accordance with examples as disclosed herein. The sampling component 2625 is configurable or configured to obtain a set of multiple samples associated with a set of multiple packets including data. The traffic pattern detection component 2630 is configurable or configured to detect one or more transmission traffic patterns associated with the set of multiple packets based on one or more parameters associated with the set of multiple samples, one or more parameters associated with a previous set of multiple samples, or both. The traffic classification component 2635 is configurable or configured to classify, based on the one or more transmission traffic patterns, the set of multiple packets according to one or more traffic types. The traffic type communication component 2640 is configurable or configured to communicate in accordance with the one or more traffic types.

In some examples, to support communicating in accordance with the one or more traffic types, the scheduling information component 2660 is configurable or configured to output scheduling information associated with the set of multiple packets, where the scheduling information is output in accordance with a channel access scheme that is based on the one or more traffic types.

In some examples, the create model component 26100 is configurable or configured to create a model to detect the one or more transmission traffic patterns. In some examples, the train model component 26105 is configurable or configured to train the model based on a stream classification service request. In some examples, the sample label component 26110 is configurable or configured to detect whether one or more portions of the set of multiple samples correspond to one or more transmission traffic types. In some examples, the sample label component 26110 is configurable or configured to label either the set of multiple samples as a set of multiple training samples for training the model or a first portion of the set of multiple samples as the set of multiple training samples, where the first portion is not detected as corresponding to a respective transmission traffic type, and where labeling the first portion is based on a second portion of the set of multiple samples corresponding to a transmission traffic type associated with the first portion. In some examples, the train model component 26105 is configurable or configured to train the model using the set of multiple training samples based on either labeling the set of multiple samples as the set of multiple training samples or labeling the first portion of the set of multiple samples as the set of multiple training samples.

In some examples, the channel access component 26125 is configurable or configured to obtain one or more channel access triggers associated with one or more channel access schemes, the one or more channel access schemes comprising the channel access scheme, where at least one of obtaining the one or more channel access triggers is based on at least one of the one or more traffic types or a compliance with a policy or outputting the scheduling information is further based on the one or more channel access triggers. In some examples, the channel access component 26125 is configurable or configured to output one or more channel access triggers associated with one or more channel access schemes, the one or more channel access schemes comprising the channel access scheme, the output being based on the one or more traffic types, where outputting the scheduling information is further based on the one or more channel access triggers.

In some examples, to support detecting the one or more transmission traffic patterns, the traffic pattern detection component 2630 is configurable or configured to detect either real-time traffic associated with a first window of the set of multiple samples or streaming traffic associated with a second of for the set of multiple samples that is longer than the first window. In some examples, to support classifying the set of multiple packets, the reclassification component 2665 is configurable or configured to reclassify the set of multiple packets based on a transmission traffic type confidence level being less than or equal to a threshold confidence level.

In some examples, to support detecting the one or more transmission traffic patterns, the AIML model input component 2670 is configurable or configured to output, to an artificial-intelligence model or machine-learning model, the one or more parameters associated with the set of multiple samples, where the one or more parameters include one or more quality of service requirements. In some examples, to support detecting the one or more transmission traffic patterns, the AIML model output component 2675 is configurable or configured to obtain, from the artificial-intelligence model or machine-learning model, the one or more transmission traffic patterns.

In some examples, the traffic pattern information component 2680 is configurable or configured to obtain traffic pattern information associated with one or more other access points, where the detection of the one or more transmission traffic patterns is further based on the traffic pattern information. In some examples, the traffic pattern indication component 2685 is configurable or configured to communicate an indication of the one or more detected transmission traffic patterns.

In some examples, the traffic condition component 2690 is configurable or configured to obtain one or more traffic activities, one or more traffic loads, or any combination thereof based on the one or more transmission traffic patterns, where the one or more traffic types, the one or more traffic activities, and the one or more traffic loads are each associated with a respective traffic flow of a set of multiple traffic flows, where the set of multiple traffic flows are associated with the set of multiple samples, where the communication includes performing a power saving operation in accordance with the one or more traffic types, the one or more traffic activities, the one or more traffic loads, or any combination thereof.

In some examples, the traffic condition component 2690 is configurable or configured to obtain one or more second traffic types, one or more second traffic activities, one or more second traffic loads, or any combination thereof. In some examples, the power saving operation component 2695 is configurable or configured to perform a second power saving operation in accordance with the one or more second traffic types, the one or more second traffic activities, the one or more second traffic loads, or any combination thereof.

In some examples, the monitoring component 26115 is configurable or configured to monitor, according to a first periodicity, for a first set of multiple traffic flows associated with a first transmission traffic type. In some examples, the monitoring component 26115 is configurable or configured to monitor, according to a second periodicity, for a second set of multiple traffic flows associated with a second transmission traffic type. In some examples, the monitoring component 26115 is configurable or configured to monitor, according to a third periodicity, for a third set of multiple traffic flows associated with a third transmission traffic type, where the set of multiple traffic flows include the first set of multiple traffic flows, the second set of multiple traffic flows, and the third set of multiple traffic flows. In some examples, the monitoring component 26115 is configurable or configured to implement, absent of a reclassification of the set of multiple traffic flows, one or more of the first transmission traffic type, the second transmission traffic type, and the third transmission traffic type, the implementation being in accordance with one or more activities associated with the first set of multiple traffic flows, the second set of multiple traffic flows, or the third set of multiple traffic flows and in accordance with a power saving operation at the wireless node.

In some examples, to support performing the power saving operation, the power saving operation component 2695 is configurable or configured to perform the power saving operation in accordance with one or more conditions being satisfied, where the one or more conditions include at least one of: a presence of a video streaming traffic type, an absence of a latency-sensitive or real-time traffic type, or a summation of one or more second traffic loads associated with a background traffic type being below or equal to a threshold traffic load, the one or more traffic loads including at least the one or more second traffic loads.

In some examples, the monitoring component 26115 is configurable or configured to monitor for the summation of the one or more second traffic loads associated with the background traffic type periodically.

Additionally, or alternatively, the second wireless communication device 2620 may support wireless communications in accordance with examples as disclosed herein. The traffic flow component 2645 is configurable or configured to obtain information associated with a traffic flow to the wireless node. In some examples, the traffic classification component 2635 is configurable or configured to obtain, in accordance with a classification of the traffic flow, an indication of a first set of values associated with an inactivity timeout and a second set of values associated with a poll period. The power management component 2650 is configurable or configured to select, at a start of a first duration and in accordance with a latency metric and a power consumption metric that are both associated with a second duration, a first value from the first set of values and a first value from the second set of values. The communication component 2655 is configurable or configured to communicate during the first duration in accordance with at least the first value from the first set of values or the first value from the second set of values.

In some examples, the power management component 2650 is configurable or configured to output a frame including an indication that the wireless node is in an awake state, where selecting the first value from the first set of values and the first value from the second set of values is in parallel with outputting the frame. In some examples, a transmission time of the frame corresponds to the start of the first duration.

In some examples, the traffic classification component 2635 is configurable or configured to obtain, in accordance with the classification of the traffic flow, an indication of a DTIM periodicity associated with the traffic flow, where communicating during the first duration is further in accordance with the DTIM periodicity. In some examples, the traffic classification component 2635 is configurable or configured to obtain, in accordance with the classification of the traffic flow, an indication of a latency constraint associated with the traffic flow, where the latency metric is associated with the latency constraint.

In some examples, the traffic classification component 2635 is configurable or configured to obtain a set of multiple frames during a sleep state associated with a previous poll period within the second duration, where at least one of: the latency metric is a normalized latency metric associated with at least one of an estimated latency or the latency constraint, or the estimated latency is associated with at least one of the set of multiple frames obtained during the sleep state or a congestion factor.

In some examples, the latency metric is equal to or greater than a threshold value. In some examples, the power consumption metric is a normalized power consumption metric associated with at least one of an estimated power or a power normalization factor. In some examples, the estimated power corresponds to a power consumption associated with at least one of a previous inactivity timeout value or a previous speculative poll period value of the second duration.

In some examples, the power management component 2650 is configurable or configured to select a sleep mode in accordance with the first value from the second set of values, where communicating during the first duration is further in accordance with the sleep mode. In some examples, to support selecting the sleep mode, the power management component 2650 is configurable or configured to select a first sleep mode in accordance with the first value from the second set of values being less than or equal to a threshold speculative poll period value. In some examples, to support selecting the sleep mode, the power management component 2650 is configurable or configured to select a second sleep mode in accordance with the first value from the second set of values being greater than or equal to the threshold speculative poll period value, where the second sleep mode is longer than the first sleep mode in time.

In some examples the power management component 2650 is configurable or configured to enter a sleep state until at least a next TBTT in accordance with the first value from the second set of values being greater than or equal to a DTIM interval or enter a partial awake state to obtain a beacon frame at the next TBTT, or re-enter the sleep state for the DTIM interval in accordance with the beacon frame lacking an indication of data activity for the wireless node.

In some examples, the selection of the first value from the first set of values and the first value from the second set of values is in accordance with a penalty value that is based on the latency metric and the power consumption metric. In some examples, the primary value is equal to a first product of the latency metric and an alpha value. In some examples, the secondary value is equal to a second product of the power consumption metric and a parenthetical of one minus the alpha value.

In some examples, the power management component 2650 is configurable or configured to update the alpha value from a first value to a second value, where a difference between the first value and the second value is associated with a difference between an estimated latency and a latency constraint associated with the traffic flow, where the estimated latency is associated with a set of multiple frames obtained during a sleep state associated with a previous speculative poll period value of the second duration and a congestion factor.

In some examples, the power management component 2650 is configurable or configured to obtain a set of multiple penalty values in accordance with a set of multiple latency metrics and power consumption metrics associated with a set of multiple durations, the set of multiple latency metrics and power consumption metrics including the latency metric and the power consumption metric, where different value pairs from the first set of values and the second set of values are associated with different penalty values of the set of multiple penalty values.

In some examples, a first pair of the first value from the first set of values and the first value from the second set of values is associated with a lowest penalty value of the set of multiple penalty values. In some examples, a second pair of a second value from the first set of values and a second value from the second set of values is associated with a lowest penalty value of the set of multiple penalty values. In some examples, at least one of the first value from the first set of values or the second value from the second set of values is proximate to at least one of the second value from the first set of values or the second value from the second set of values.

In some examples, to support communicating in accordance with at least the first value from the first set of values or the first value from the second set of values, the communication component 2655 is configurable or configured to output a first frame indicating that the wireless node is in an awake state, where the first frame is output based on the first value from the second set of values. In some examples, to support communicating in accordance with at least the first value from the first set of values or the first value from the second set of values, the communication component 2655 is configurable or configured to output, a second frame indicating that the wireless node is in a sleep state, where the second frame is output based on the first value from the first set of values. In some examples, the second duration is immediately previous in time to the first duration.

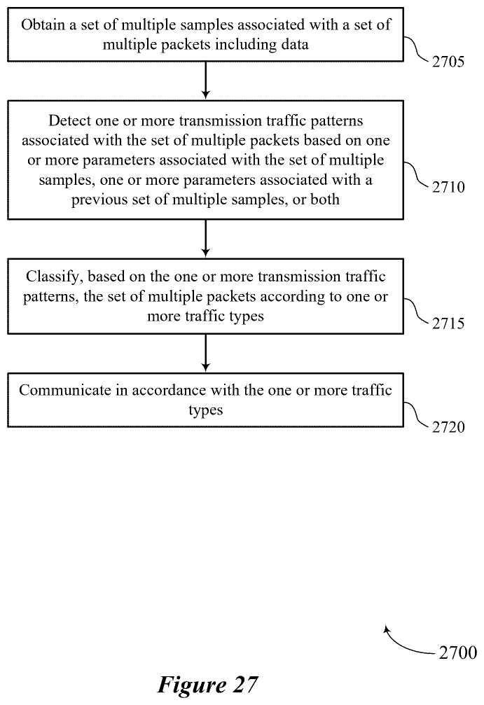

FIG. 27 shows a flowchart illustrating a method 2700 that supports a traffic classifier for service aware Wi-Fi operation. The operations of the method 2700 may be implemented by a first wireless communication device (such as an AP 102) or a second wireless communication device (such as a STA 104) or its components as described herein. For example, the operations of the method 2700 may be performed by an AP 102 as described with reference to FIGS. 1 through 25 or a STA 104 as described with reference to FIGS. 1 through 24 and 26. In some examples, a first wireless communication device or a second wireless communication device may execute a set of instructions to control the functional elements of the first wireless communication device or the second wireless communication device to perform the described functions. Additionally, or alternatively, the first wireless communication device or the second wireless communication device may perform aspects of the described functions using special-purpose hardware.

At 2705, the method may include obtaining a set of multiple samples associated with a set of multiple packets including data. The operations of 2705 may be performed in accordance with examples as disclosed herein. In some examples, aspects of the operations of 2705 may be performed by a sampling component 2525 or a sampling component 2625 as described with reference to FIGS. 25 and 26.

At 2705, the method may include obtaining a set of multiple samples associated with a set of multiple packets including data. The operations of 2705 may be performed in accordance with examples as disclosed herein. In some examples, aspects of the operations of 2705 may be performed by a sampling component 2525 or a sampling component 2625 as described with reference to FIGS. 25 and 26.

At 2710, the method may include detecting one or more transmission traffic patterns associated with the set of multiple packets based on one or more parameters associated with the set of multiple samples, one or more parameters associated with a previous set of multiple samples, or both. The operations of 2710 may be performed in accordance with examples as disclosed herein. In some examples, aspects of the operations of 2710 may be performed by a traffic pattern detection component 2530 or a traffic pattern detection component 2630 as described with reference to FIGS. 25 and 26.

At 2715, the method may include classifying, based on the one or more transmission traffic patterns, the set of multiple packets according to one or more traffic types. The operations of 2715 may be performed in accordance with examples as disclosed herein. In some examples, aspects of the operations of 2715 may be performed by a traffic classification component 2535 or a traffic classification component 2635 as described with reference to FIGS. 25 and 26.

At 2720, the method may include communicating in accordance with the one or more traffic types. The operations of 2720 may be performed in accordance with examples as disclosed herein. In some examples, aspects of the operations of 2720 may be performed by a traffic type communication component 2540 or a traffic type communication component 2640 as described with reference to FIGS. 25 and 26.

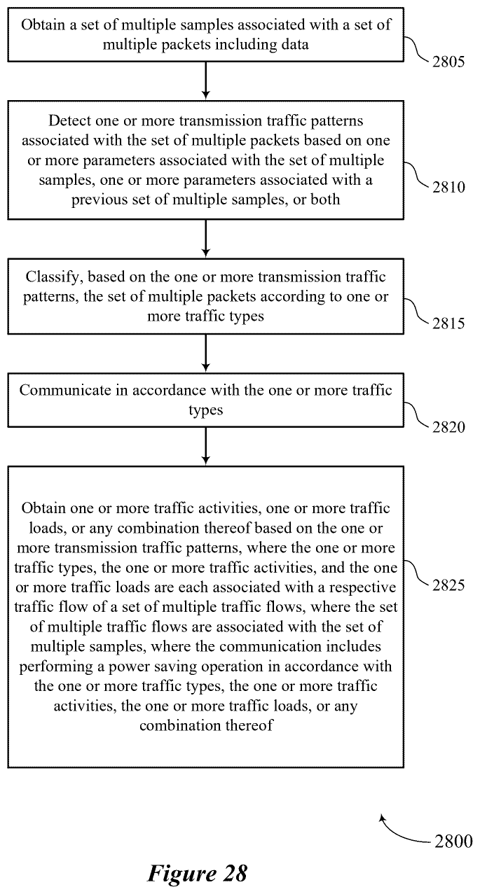

FIG. 28 shows a flowchart illustrating a method 2800 that supports a traffic classifier for service aware Wi-Fi operation. The operations of the method 2800 may be implemented by a first wireless communication device (such as an AP 102) or a second wireless communication device (such as a STA 104) or its components as described herein. For example, the operations of the method 2800 may be performed by an AP 102 as described with reference to FIGS. 1 through 25 or a STA 104 as described with reference to FIGS. 1 through 24 and 26. In some examples, a first wireless communication device or a second wireless communication device may execute a set of instructions to control the functional elements of the first wireless communication device or the second wireless communication device to perform the described functions. Additionally, or alternatively, the first wireless communication device or the second wireless communication device may perform aspects of the described functions using special-purpose hardware.

At 2805, the method may include obtaining a set of multiple samples associated with a set of multiple packets including data. The operations of 2805 may be performed in accordance with examples as disclosed herein. In some examples, aspects of the operations of 2805 may be performed by a sampling component 2525 or a sampling component 2625 as described with reference to FIGS. 25 and 26.

At 2810, the method may include detecting one or more transmission traffic patterns associated with the set of multiple packets based on one or more parameters associated with the set of multiple samples, one or more parameters associated with a previous set of multiple samples, or both. The operations of 2810 may be performed in accordance with examples as disclosed herein. In some examples, aspects of the operations of 2810 may be performed by a traffic pattern detection component 2530 or a traffic pattern detection component 2630 as described with reference to FIGS. 25 and 26.

At 2815, the method may include classifying, based on the one or more transmission traffic patterns, the set of multiple packets according to one or more traffic types. The operations of 2815 may be performed in accordance with examples as disclosed herein. In some examples, aspects of the operations of 2815 may be performed by a traffic classification component 2535 or a traffic classification component 2635 as described with reference to FIGS. 25 and 26.

At 2820, the method may include communicating in accordance with the one or more traffic types. The operations of 2820 may be performed in accordance with examples as disclosed herein. In some examples, aspects of the operations of 2820 may be performed by a traffic type communication component 2540 or a traffic type communication component 2640 as described with reference to FIGS. 25 and 26.

At 2825, the method may include obtaining one or more traffic activities, one or more traffic loads, or any combination thereof based on the one or more transmission traffic patterns, where the one or more traffic types, the one or more traffic activities, and the one or more traffic loads are each associated with a respective traffic flow of a set of multiple traffic flows, where the set of multiple traffic flows are associated with the set of multiple samples, where the communication includes performing a power saving operation in accordance with the one or more traffic types, the one or more traffic activities, the one or more traffic loads, or any combination thereof. The operations of 2825 may be performed in accordance with examples as disclosed herein. In some examples, aspects of the operations of 2825 may be performed by a traffic condition component 2575 or a traffic condition component 2690 as described with reference to FIGS. 25 and 26.

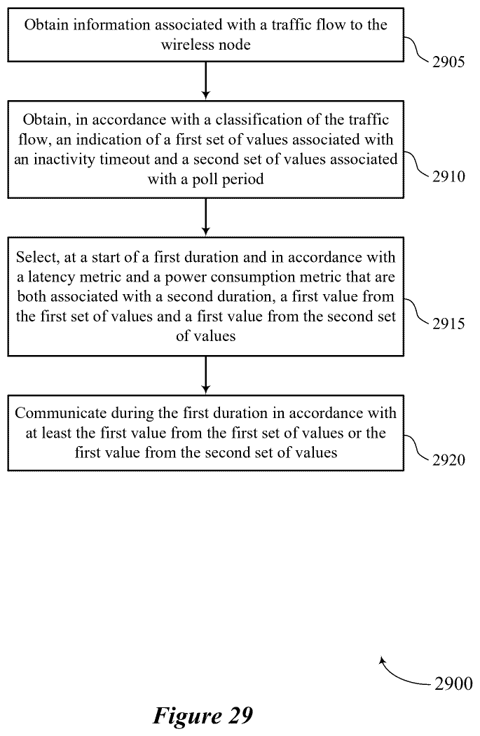

FIG. 29 shows a flowchart illustrating a method 2900 that supports a traffic classifier for service aware Wi-Fi operation. The operations of the method 2900 may be implemented by a second wireless communication device (such as a STA 104) or its components as described herein. For example, the operations of the method 2900 may be performed by a second wireless communication device as described with reference to FIGS. 1 through 24 and 26. In some examples, a second wireless communication device may execute a set of instructions to control the functional elements of the second wireless communication device to perform the described functions. Additionally, or alternatively, the second wireless communication device may perform aspects of the described functions using special-purpose hardware.

At 2905, the method may include obtaining information associated with a traffic flow to the wireless node. The operations of 2905 may be performed in accordance with examples as disclosed herein. In some examples, aspects of the operations of 2905 may be performed by a traffic flow component 2645 as described with reference to FIG. 26.

At 2910, the method may include obtaining, in accordance with a classification of the traffic flow, an indication of a first set of values associated with an inactivity timeout and a second set of values associated with a poll period. The operations of 2910 may be performed in accordance with examples as disclosed herein. In some examples, aspects of the operations of 2910 may be performed by a traffic classification component 2635 as described with reference to FIG. 26.

At 2915, the method may include selecting, at a start of a first duration and in accordance with a latency metric and a power consumption metric that are both associated with a second duration, a first value from the first set of values and a first value from the second set of values. The operations of 2915 may be performed in accordance with examples as disclosed herein. In some examples, aspects of the operations of 2915 may be performed by a power management component 2650 as described with reference to FIG. 26.

At 2920, the method may include communicating during the first duration in accordance with at least the first value from the first set of values or the first value from the second set of values. The operations of 2920 may be performed in accordance with examples as disclosed herein. In some examples, aspects of the operations of 2920 may be performed by a communication component 2655 as described with reference to FIG. 26.

Implementation examples are described in the following numbered clauses:
Aspect 1: A method for wireless communication at a wireless node, the method comprising: obtaining a plurality of samples associated with a plurality of packets comprising data; detecting one or more transmission traffic patterns associated with the plurality of packets based at least in part on one or more parameters associated with the plurality of samples, one or more parameters associated with a previous plurality of samples, or both; classifying, based at least in part on the one or more transmission traffic patterns, the plurality of packets according to one or more traffic types; and communicating in accordance with the one or more traffic types.
Aspect 2: The method of aspect 1, wherein communicating in accordance with the one or more traffic types comprises: outputting scheduling information associated with the plurality of packets, wherein the scheduling information is output in accordance with a channel access scheme that is based at least in part on the one or more traffic types.
Aspect 3: The method of any of aspects 1 through 2, further comprising: creating a model to detect the one or more transmission traffic patterns; training the model based at least in part on a stream classification service request; detecting whether one or more portions of the plurality of samples correspond to one or more transmission traffic types; labeling either the plurality of samples as a plurality of training samples for training the model or a first portion of the plurality of samples as the plurality of training samples, wherein the first portion is not detected as corresponding to a respective transmission traffic type, and wherein labeling the first portion is based at least in part on a second portion of the plurality of samples corresponding to a transmission traffic type associated with the first portion; and training the model using the plurality of training samples based on either labeling the plurality of samples as the plurality of training samples or labeling the first portion of the plurality of samples as the plurality of training samples.
Aspect 4: The method of any of aspects 2 through 3, further comprising: obtaining one or more channel access triggers associated with one or more channel access schemes, the one or more channel access schemes comprising the channel access scheme, wherein at least one of: obtaining the one or more channel access triggers is based at least in part on at least one of the one or more traffic types or a compliance with a policy; or outputting the scheduling information is further based at least in part on the one or more channel access triggers.
Aspect 5: The method of any of aspects 2 through 4, further comprising: outputting one or more channel access triggers associated with one or more channel access schemes, the one or more channel access schemes comprising the channel access scheme, the output being based at least in part on the one or more traffic types, wherein outputting the scheduling information is further based at least in part on the one or more channel access triggers.
Aspect 6: The method of any of aspects 1 through 5, wherein detecting the one or more transmission traffic patterns comprises: detecting either real-time traffic associated with a first window of the plurality of samples or streaming traffic associated with a second window of the plurality of samples that is longer than the first window.
Aspect 7: The method of any of aspects 1 through 6, wherein classifying the plurality of packets comprises: reclassifying the plurality of packets based at least in part on a transmission traffic type confidence level being less than or equal to a threshold confidence level.
Aspect 8: The method of any of aspects 1 through 7, wherein detecting the one or more transmission traffic patterns comprises: outputting, to an artificial-intelligence model or machine-learning model, the one or more parameters associated with the plurality of samples, wherein the one or more parameters comprise one or more quality of service requirements; and obtaining, from the artificial-intelligence model or machine-learning model, the one or more transmission traffic patterns.
Aspect 9: The method of any of aspects 1 through 8, further comprising: obtaining traffic pattern information associated with one or more other access points, where the detection of the one or more transmission traffic patterns is further based at least in part on the traffic pattern information; and communicating an indication of the one or more detected transmission traffic patterns.
Aspect 10: The method of any of aspects 1 through 9, further comprising: obtaining one or more traffic activities, one or more traffic loads, or any combination thereof based at least in part on the one or more transmission traffic patterns, wherein the one or more traffic types, the one or more traffic activities, and the one or more traffic loads are each associated with a respective traffic flow of a plurality of traffic flows, wherein the plurality of traffic flows are associated with the plurality of samples, wherein: the communication comprises performing a power saving operation in accordance with the one or more traffic types, the one or more traffic activities, the one or more traffic loads, or any combination thereof.
Aspect 11: The method of aspect 10, further comprising: obtaining one or more second traffic types, one or more second traffic activities, one or more second traffic loads, or any combination thereof; and performing a second power saving operation in accordance with the one or more second traffic types, the one or more second traffic activities, the one or more second traffic loads, or any combination thereof.
Aspect 12: The method of aspect 11, further comprising: monitoring, according to a first periodicity, for a first plurality of traffic flows associated with a first transmission traffic type; monitoring, according to a second periodicity, for a second plurality of traffic flows associated with a second transmission traffic type; monitoring, according to a third periodicity, for a third plurality of traffic flows associated with a third transmission traffic type, wherein the plurality of traffic flows comprise the first plurality of traffic flows, the second plurality of traffic flows, and the third plurality of traffic flows; and implementing, absent of a reclassification of the plurality of traffic flows, one or more of the first transmission traffic type, the second transmission traffic type, and the third transmission traffic type, the implementation being in accordance with one or more activities associated with the first plurality of traffic flows, the second plurality of traffic flows, or the third plurality of traffic flows and in accordance with a power saving operation at the wireless node.
Aspect 13: The method of any of aspects 10 through 12, wherein performing the power saving operation comprises: performing the power saving operation in accordance with one or more conditions being satisfied, wherein the one or more conditions comprise at least one of: a presence of a video streaming traffic type; an absence of a latency-sensitive or real-time traffic type; or a summation of one or more second traffic loads associated with a background traffic type being below or equal to a threshold traffic load, the one or more traffic loads comprising at least the one or more second traffic loads.
Aspect 14: The method of aspect 13, further comprising: monitoring for the summation of the one or more second traffic loads associated with the background traffic type periodically.
Aspect 15: A method for wireless communications at a wireless node, the method comprising: obtaining information associated with a traffic flow to the wireless node; obtaining, in accordance with a classification of the traffic flow, an indication of a first set of values associated with an inactivity timeout and a second set of values associated with a poll period; selecting, at a start of a first duration and in accordance with a latency metric and a power consumption metric that are both associated with a second duration, a first value from the first set of values and a first value from the second set of values; and communicating during the first duration in accordance with at least one of the first value from the first set of values or the first value from the second set of values.
Aspect 16: The method of aspect 15, further comprising: outputting a frame including an indication that the wireless node is in an awake state, wherein selecting the first value from the first set of values and the first value from the second set of values is in parallel with outputting the frame.
Aspect 17: The method of aspect 16, wherein a transmission time of the frame corresponds to the start of the first duration.
Aspect 18: The method of any of aspects 15 through 17, further comprising: obtaining, in accordance with the classification of the traffic flow, an indication of a DTIM periodicity associated with the traffic flow, wherein communicating during the first duration is further in accordance with the DTIM periodicity.
Aspect 19: The method of any of aspects 15 through 18, further comprising: obtaining, in accordance with the classification of the traffic flow, an indication of a latency constraint associated with the traffic flow, wherein the latency metric is associated with the latency constraint.
Aspect 20: The method of aspect 19, further comprising: obtaining a plurality of frames during a sleep state associated with a previous poll period within the second duration, wherein at least one of: the latency metric is a normalized latency metric associated with at least one of an estimated latency or the latency constraint, or the estimated latency is associated with at least one of the plurality of frames obtained during the sleep state or a congestion factor.
Aspect 21: The method of aspect 20, wherein the latency metric is equal to or greater than a threshold value.
Aspect 22: The method of any of aspects 15 through 21, wherein at least one of the power consumption metric is a normalized power consumption metric associated with at least one of an estimated power or a power normalization factor, or the estimated power corresponds to a power consumption associated with at least one of a previous inactivity timeout value or a previous speculative poll period value of the second duration.
Aspect 23: The method of any of aspects 15 through 22, further comprising: selecting a sleep mode in accordance with the first value from the second set of values, wherein communicating during the first duration is further in accordance with the sleep mode.
Aspect 24: The method of aspect 23, wherein selecting the sleep mode comprises: selecting a first sleep mode in accordance with the first value from the second set of values being less than or equal to a threshold speculative poll period value; or selecting a second sleep mode in accordance with the first value from the second set of values being greater than or equal to the threshold speculative poll period value, wherein the second sleep mode is longer than the first sleep mode in time.
Aspect 25: The method of any of aspects 15 through 24, further comprising: entering a sleep state until at least a next TBTT in accordance with the first value from the second set of values being greater than or equal to the DTIM interval, or re-entering the sleep state for the DTIM interval in accordance with the beacon frame lacking an indication of data activity for the wireless node.
Aspect 26: The method of any of aspects 15 through 25, wherein the selection of the first value comprises selecting the first value in accordance with a penalty value that is based on the latency metric and the power consumption metric.
Aspect 27: The method of aspect 26, wherein the penalty value is associated with a summation of a primary value and a secondary value, wherein at least one of the primary value is equal to a first product of the latency metric and an alpha value, or the secondary value is equal to a second product of the power consumption metric and a parenthetical of one minus the alpha value.
Aspect 28: The method of aspect 27, further comprising: updating the alpha value from a first value to a second value, wherein a difference between the first value and the second value is associated with a difference between an estimated latency and a latency constraint associated with the traffic flow, wherein the estimated latency is associated with a plurality of frames obtained during a sleep state associated with a previous speculative poll period value of the second duration and a congestion factor.
Aspect 29: The method of any of aspects 15 through 28, further comprising: obtaining a plurality of penalty values in accordance with a plurality of latency metrics and power consumption metrics associated with a plurality of durations, the plurality of latency metrics and power consumption metrics comprising the latency metric and the power consumption metric, wherein different value pairs from the first set of values and the second set of values are associated with different penalty values of the plurality of penalty values.
Aspect 30: The method of aspect 29, wherein a first pair of the first value from the first set of values and the first value from the second set of values is associated with a lowest penalty value of the plurality of penalty values.
Aspect 31: The method of any of aspects 29 through 30, wherein at least one of a second pair of a second value from the first set of values and a second value from the second set of values is associated with a lowest penalty value of the plurality of penalty values, or at least one of the first value from the first set of values or the second value from the second set of values is proximate to at least one of the second value from the first set of values or the second value from the second set of values.
Aspect 32: The method of any of aspects 15 through 31, wherein communicating in accordance with at least the first value from the first set of values or the first value from the second set of values comprises: outputting a first frame indicating that the wireless node is in an awake state, wherein the first frame is output based on the first value from the second set of values; or outputting, a second frame indicating that the wireless node is in a sleep state, wherein the second frame is output based at least in part on the first value from the first set of values.
Aspect 33: The method of any of aspects 15 through 32, wherein the second duration is immediately previous in time to the first duration.
Aspect 34: A wireless node, including at least one transceiver and a processing system that includes processor circuitry and memory circuitry that stores code, the processing system configured to cause the wireless node to perform the method of any of aspects 1 through 14, wherein the at least one transceiver is configured to receive the plurality of samples.
Aspect 35: An apparatus for wireless communication, including a processing system that includes processor circuitry and memory circuitry that stores code, the processing system configured to cause the apparatus to perform the method of any of aspects 1 through 14.
Aspect 36: An apparatus for wireless communication, comprising at least one means for performing a method of any of aspects 1 through 14.
Aspect 37: A non-transitory computer-readable medium storing code for wireless communication, the code comprising instructions executable by one or more processors to perform a method of any of aspects 1 through 14.
Aspect 38: A wireless node, including at least one transceiver; and a processing system that includes processing circuitry and memory circuitry that stores code, the processing system configured to cause the wireless node to perform the method of any of aspects 15 through 33, wherein the at least one transceiver is configured to receive the information and receive the indication.
Aspect 39: An apparatus for wireless communication, including a processing system that includes processor circuitry and memory circuitry that stores code, the processing system configured to cause the apparatus to perform the method of any of aspects 15 through 33.
Aspect 40: An apparatus for wireless communications, comprising at least one means for performing a method of any of aspects 15 through 33.
Aspect 41: A non-transitory computer-readable medium storing code for wireless communications, the code comprising instructions executable by one or more processors to perform a method of any of aspects 15 through 33.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication, comprising:
a processing system that includes processor circuitry and memory circuitry that stores code, the processing system configured to cause the apparatus to:
obtain a plurality of samples associated with a plurality of packets comprising data;
detect one or more transmission traffic patterns associated with the plurality of packets based at least in part on one or more parameters associated with the plurality of samples, one or more parameters associated with a previous plurality of samples, or both;
classify, based at least in part on the one or more transmission traffic patterns, the plurality of packets according to one or more traffic types; and
communicate in accordance with the one or more traffic types.

2. The apparatus of claim 1, wherein, to communicate in accordance with the one or more traffic types, the processing system is configured to cause the apparatus to:
output scheduling information associated with the plurality of packets, wherein the scheduling information is output in accordance with a channel access scheme that is based at least in part on the one or more traffic types.

3. The apparatus of claim 2, wherein the processing system is further configured to cause the apparatus to:
obtain one or more channel access triggers associated with one or more channel access schemes, the one or more channel access schemes comprising the channel access scheme, wherein at least one of:
obtaining the one or more channel access triggers is based at least in part on at least one of the one or more traffic types or a compliance with a policy; or
outputting the scheduling information is further based at least in part on the one or more channel access triggers.

4. The apparatus of claim 2, wherein the processing system is further configured to cause the apparatus to:
output one or more channel access triggers associated with one or more channel access schemes, the one or more channel access schemes comprising the channel access scheme, and the output being based at least in part on the one or more traffic types, wherein outputting the scheduling information is further based at least in part on the one or more channel access triggers.

5. The apparatus of claim 1, wherein the processing system is further configured to cause the apparatus to:
create a model to detect the one or more transmission traffic patterns;
train the model based at least in part on a stream classification service request;
detect whether one or more portions of the plurality of samples correspond to the one or more transmission traffic types;
label, either the plurality of samples as a plurality of training samples for training the model or a first portion of the plurality of samples as the plurality of training samples, wherein the first portion is not detected as corresponding to a respective transmission traffic type, wherein labeling the first portion is based at least in part on a second portion of the plurality of samples corresponding to a transmission traffic type associated with the first portion; and
train the model using the plurality of training samples based on either labeling the plurality of samples as the plurality of training samples or labeling the first portion of the plurality of samples as the plurality of training samples.

6. The apparatus of claim 1, wherein, to detect the one or more transmission traffic patterns, the processing system is further configured to cause the apparatus to:
detect either real-time traffic associated with a first window of the plurality of samples or streaming traffic associated with a second window of the plurality of samples that is longer than the first window.

7. The apparatus of claim 1, wherein, to classify the plurality of packets, the processing system is further configured to cause the apparatus to:
reclassify the plurality of packets based at least in part on a transmission traffic type confidence level being less than or equal to a threshold confidence level.

8. The apparatus of claim 1, wherein, to detect the one or more transmission traffic patterns, the processing system is further configured to cause the apparatus to:
output, to an artificial-intelligence model or machine-learning model, the one or more parameters associated with the plurality of samples, wherein the one or more parameters comprise one or more quality of service requirements; and
obtain, from the artificial-intelligence model or machine-learning model, the one or more transmission traffic patterns.

9. The apparatus of claim 1, wherein the processing system is further configured to cause the apparatus to:
obtain traffic pattern information associated with one or more other access points, wherein the detection of the one or more transmission traffic patterns is further based at least in part on the traffic pattern information; and
communicate an indication of the one or more detected transmission traffic patterns.

10. The apparatus of claim 1, wherein the processing system is further configured to cause the apparatus to:
obtain one or more traffic activities, one or more traffic loads, or any combination thereof based at least in part on the one or more transmission traffic patterns, wherein the one or more traffic types, the one or more traffic activities, and the one or more traffic loads are each associated with a respective traffic flow of a plurality of traffic flows, wherein the plurality of traffic flows are associated with the plurality of samples, wherein:
the communication comprises performing a power saving operation in accordance with the one or more traffic types, the one or more traffic activities, the one or more traffic loads, or any combination thereof.

11. The apparatus of claim 10, wherein the processing system is further configured to cause the apparatus to:
obtain one or more second traffic types, one or more second traffic activities, one or more second traffic loads, or any combination thereof; and
perform a second power saving operation in accordance with the one or more second traffic types, the one or more second traffic activities, the one or more second traffic loads, or any combination thereof.

12. The apparatus of claim 10, wherein, to perform the power saving operation, the processing system is further configured to cause the apparatus to:
perform the power saving operation in accordance with one or more conditions being satisfied, wherein the one or more conditions comprise at least one of:
a presence of a video streaming traffic type;
an absence of a latency-sensitive or real-time traffic type; or
a summation of one or more second traffic loads associated with a background traffic type being below or equal to a threshold traffic load, the one or more traffic loads comprising at least the one or more second traffic loads.

13. A method for wireless communications at a wireless node, the method comprising:
obtaining a plurality of samples associated with a plurality of packets comprising data;
detecting one or more transmission traffic patterns associated with the plurality of packets based at least in part on one or more parameters associated with the plurality of samples, one or more parameters associated with a previous plurality of samples, or both;
classifying, based at least in part on the one or more transmission traffic patterns, the plurality of packets according to one or more traffic types; and
communicating in accordance with the one or more traffic types.

14. The method of claim 13, wherein communicating in accordance with the one or more traffic types comprises:
outputting scheduling information associated with the plurality of packets, wherein the scheduling information is output in accordance with a channel access scheme that is based at least in part on the one or more traffic types.

15. The method of claim 13, wherein detecting the one or more transmission traffic patterns comprises:
detecting either real-time traffic associated with a first window of the plurality of samples or streaming traffic associated with a second window of the plurality of samples that is longer than the first window.

16. The method of claim 13, further comprising:
obtaining one or more traffic activities, one or more traffic loads, or any combination thereof based at least in part on the one or more transmission traffic patterns, wherein the one or more traffic types, the one or more traffic activities, and the one or more traffic loads are each associated with a respective traffic flow of a plurality of traffic flows, wherein the plurality of traffic flows are associated with the plurality of samples, wherein:
the communication comprises performing a power saving operation in accordance with the one or more traffic types, the one or more traffic activities, the one or more traffic loads, or any combination thereof.

17. The method of claim 16, further comprising:
obtaining one or more second traffic types, one or more second traffic activities, one or more second traffic loads, or any combination thereof; and
performing a second power saving operation in accordance with the one or more second traffic types, the one or more second traffic activities, the one or more second traffic loads, or any combination thereof.

18. A wireless node for wireless communication, comprising:
at least one transceiver; and
a processing system that includes processor circuitry and memory circuitry that stores code, the processing system configured to cause the wireless node to:
receive, via the at least one transceiver, a plurality of samples associated with a plurality of packets comprising data;
detect one or more transmission traffic patterns associated with the plurality of packets based at least in part on one or more parameters associated with the plurality of samples, one or more parameters associated with a previous plurality of samples, or both;
classify, based at least in part on the one or more transmission traffic patterns, the plurality of packets according to one or more traffic types; and
communicate in accordance with the one or more traffic types.

19. The wireless node of claim 18, wherein, to communicate in accordance with the one or more traffic types, the processing system is configured to cause the wireless node to:
transmit, via the at least one transceiver, scheduling information associated with the plurality of packets, wherein the scheduling information is transmitted in accordance with a channel access scheme that is based at least in part on the one or more traffic types.

20. The wireless node of claim 18, wherein the processing system is further configured to cause the wireless node to:
receive, via the at least one transceiver, one or more traffic activities, one or more traffic loads, or any combination thereof based at least in part on the one or more transmission traffic patterns, wherein the one or more traffic types, the one or more traffic activities, and the one or more traffic loads are each associated with a respective traffic flow of a plurality of traffic flows, wherein the plurality of traffic flows are associated with the plurality of samples, wherein:
the communication comprises performing a power saving operation in accordance with the one or more traffic types, the one or more traffic activities, the one or more traffic loads, or any combination thereof.
